(19) United States
(12) Patent Application Publication
(10) Pub. No.: US 2026/0298159 A1
(43) Pub. Date: Oct. 1, 2026

(54) FUEL SUPPLY APPARATUS AND ENGINE SYSTEM

(71) Applicant: YANMAR HOLDINGS CO., LTD., Osaka (JP)

(72) Inventors: Hayato SAWADA, Osaka (JP); Masato SUGIMOTO, Osaka (JP); Takanori SAKAI, Osaka (JP); Yusei FUKUDA, Osaka (JP)

(73) Assignee: YANMAR HOLDINGS CO., LTD., Osaka (JP)

(21) Appl. No.: 19/551,837

(22) Filed: Feb. 27, 2026

(30) Foreign Application Priority Data
Mar. 25, 2025 (JP) 2025-050184
Mar. 25, 2025 (JP) 2025-050187
Mar. 25, 2025 (JP) 2025-050188
Nov. 7, 2025 (JP) 2025-188114
Nov. 7, 2025 (JP) 2025-188115
Nov. 7, 2025 (JP) 2025-188116

(51) Int. Cl. F02D 1/04; F02D 1/00

(52) U.S. Cl. CPC F02D 1/04; F02D 2001/0045

(57) ABSTRACT

To provide a fuel supply apparatus and an engine system that easily enhance resistance to illegal modification. A fuel supply apparatus supplies fuel to an engine body, and includes a governor mechanism that adjusts a supply amount of the fuel to the engine body. The governor mechanism includes an adjustment portion, and a sealing portion. The adjustment portion is tightened and fixed to a body and adjusts at least one of an upper limit and a lower limit of the supply amount of the fuel to the engine body in accordance with an amount of tightening relative to the body. The sealing portion restricts a change in the amount of tightening of the adjustment portion.

This application claims priority under 35 U.S.C. § 119(a) to Japanese Patent Application Nos. 2025-050187, 2025-050184, and 2025-050188, all filed on Mar. 25, 2025, and Japanese Patent Application Nos. 2025-188115, 2025-188116, and 2025-188114, all filed on Nov. 7, 2025, for subject matter first disclosed therein, the entire contents of each of which are incorporated herein by reference.

### TECHNICAL FIELD

The present disclosure relates to a fuel supply apparatus including a governor mechanism, and an engine system.

### BACKGROUND ART

As related art, it is known that a fuel supply apparatus that supplies (injects) fuel from a fuel injection pump to an engine body (diesel engine) includes a governor mechanism (mechanical governor) that adjusts the supply amount of fuel (e.g., refer to Patent Document 1). The governor mechanism of the related art adjusts the supply amount of fuel by sliding a metering rack pin of a fuel metering rack of the fuel injection pump in a fuel increasing or reducing direction.

In this governor mechanism, a connector is attached to a lever member (governor lever), and a rack pin engagement portion provided on the connector is engaged with the metering rack pin of the fuel injection pump. In this type of governor mechanism, contact of the lever member with an adjustment portion (fuel limiter) limits a movable range of the lever member, which limits (an upper limit and/or a lower limit of) the supply amount of fuel. In the related art, the connector is formed of sheet metal, and a bent portion formed by bending a part of the sheet metal constitutes the rack pin engagement portion.

### PRIOR ART DOCUMENT

### Patent Document

Patent Document 1: JP 2000-352333 A

### SUMMARY OF INVENTION

### Technical Problem

In the configuration of the above-mentioned related art, the supply amount of fuel is limited by the lever member contacting the adjustment portion. Thus, for example, if the lever member and/or the adjustment portion is tampered with through illegal modification, a function required of the governor mechanism may not be exhibited.

It is an object of the present disclosure to provide a fuel supply apparatus and an engine system that easily enhance resistance to illegal modification.

### Solution to Problem

A fuel supply apparatus according to an aspect of the present disclosure is a fuel supply apparatus that supplies fuel to an engine body and includes a governor mechanism that adjusts a supply amount of the fuel to the engine body. The governor mechanism includes an adjustment portion, and a sealing portion. The adjustment portion is tightened and fixed to a body and adjusts at least one of an upper limit and a lower limit of the supply amount of the fuel to the engine body in accordance with an amount of tightening relative to the body. The sealing portion restricts a change in the amount of tightening of the adjustment portion.

In addition, a fuel supply apparatus according to an aspect of the present disclosure is a fuel supply apparatus that supplies fuel to an engine body and includes a governor mechanism that adjusts a supply amount of the fuel to the engine body. The governor mechanism includes a lever member, and an adjustment portion. The lever member is rotatably supported relative to a body. The adjustment portion adjusts a movable range of the lever member. The lever member includes a maintaining structure that maintains a positional relationship with the adjustment portion.

In addition, a fuel supply apparatus according to an aspect of the present disclosure is a fuel supply apparatus that supplies fuel to an engine body and includes a governor mechanism that adjusts a supply amount of the fuel to the engine body. The governor mechanism includes a lever member, an adjustment portion, and a cover member. The lever member is rotatably supported relative to a body. The adjustment portion adjusts a movable range of the lever member. The cover member covers at least one of the lever member and the adjustment portion.

An engine system according to an aspect of the present disclosure includes the fuel supply apparatus, and the engine body.

### Advantageous Effects of Invention

The present disclosure makes it possible to provide a fuel supply apparatus and an engine system that easily enhance resistance to illegal modification.

### BRIEF DESCRIPTION OF DRAWINGS

FIG. 1 is a system diagram showing the schematic configuration of an engine system according to a first embodiment;

FIG. 2 is a schematic perspective view of an engine body of the engine system according to the first embodiment;

FIG. 3 is a schematic perspective view of the engine body of the engine system according to the first embodiment;

FIG. 4 is a schematic left side view of the engine body of the engine system according to the first embodiment;

FIG. 5 is a schematic side view of a fuel supply apparatus of the engine system according to the first embodiment;

FIG. 6 shows a principal part of the fuel supply apparatus of the engine system according to the first embodiment and is a schematic enlarged view of an area Z1 in FIG. 5;

FIG. 7 is a schematic perspective view of the fuel supply apparatus of the engine system according to the first embodiment;

FIG. 8 shows a principal part of the fuel supply apparatus of the engine system according to the first embodiment and is a schematic enlarged view of an area Z1 in FIG. 7;

FIG. 9 shows a principal part of the fuel supply apparatus of the engine system according to the first embodiment and is a schematic perspective view with a cap detached;

FIG. 10 is a schematic sectional view showing a principal part of the fuel supply apparatus of the engine system according to the first embodiment;

FIG. 11 is a schematic perspective view of the fuel supply apparatus of the engine system according to the first embodiment;

FIG. 12 is a schematic perspective view showing a lever member of the fuel supply apparatus of the engine system according to the first embodiment;

FIG. 13 is a schematic perspective view of the fuel supply apparatus of the engine system according to the first embodiment;

FIG. 14 is a schematic side view of the fuel supply apparatus of the engine system according to the first embodiment;

FIG. 15 is a schematic perspective view of the fuel supply apparatus of the engine system according to the first embodiment with a cover member detached;

FIG. 16 is a schematic perspective view of the fuel supply apparatus of the engine system according to the first embodiment with the cover member detached;

FIG. 17 is a schematic sectional view showing a principal part of the fuel supply apparatus of the engine system according to the first embodiment;

FIG. 18 is a schematic sectional view showing a principal part of the fuel supply apparatus of the engine system according to the first embodiment;

FIG. 19 is a schematic sectional view showing a principal part of the fuel supply apparatus of the engine system according to the first embodiment;

FIG. 20 is a schematic perspective view of a fuel supply apparatus of an engine system according to a second embodiment;

FIG. 21 shows a principal part of the fuel supply apparatus of the engine system according to the second embodiment and is a schematic enlarged view (assembly diagram) and a schematic exploded view of an area Z1 in FIG. 20;

FIG. 22 is a schematic perspective view showing a guard member of the fuel supply apparatus of the engine system according to the second embodiment;

FIG. 23 is a schematic sectional view showing a principal part of the fuel supply apparatus of the engine system according to the second embodiment;

FIG. 24 is a schematic perspective view of a fuel supply apparatus of an engine system according to a third embodiment;

FIG. 25 shows a principal part of the fuel supply apparatus of the engine system according to the third embodiment and is a schematic enlarged view of an area Z1 in FIG. 24;

FIG. 26 is a schematic perspective view showing a principal part of the fuel supply apparatus of the engine system according to the third embodiment;

FIG. 27 is a schematic perspective view of the fuel supply apparatus of the engine system according to the third embodiment; and

FIG. 28 is a schematic plan view of the fuel supply apparatus of the engine system according to the third embodiment.

### DESCRIPTION OF EMBODIMENTS

Hereinbelow, embodiments of the present disclosure will be described with reference to the accompanying drawings. The following embodiments are examples embodying the present disclosure and are not intended to limit the technical scope of the present disclosure. The drawings referenced in the present disclosure are all schematic diagrams, and ratios of sizes and thicknesses of components in the drawings do not necessarily reflect actual dimensional ratios.

### First Embodiment

### [1] Entire Configuration

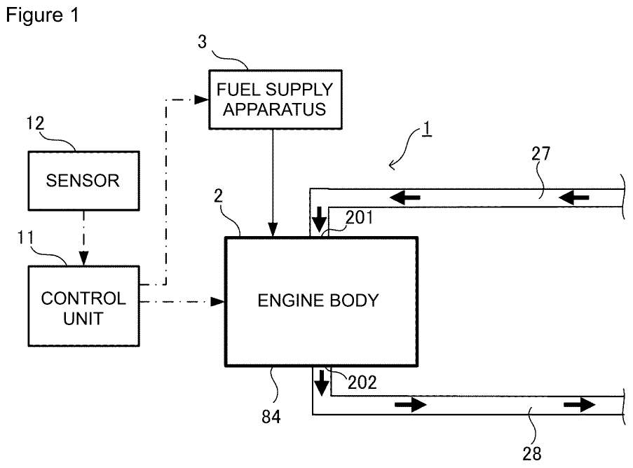

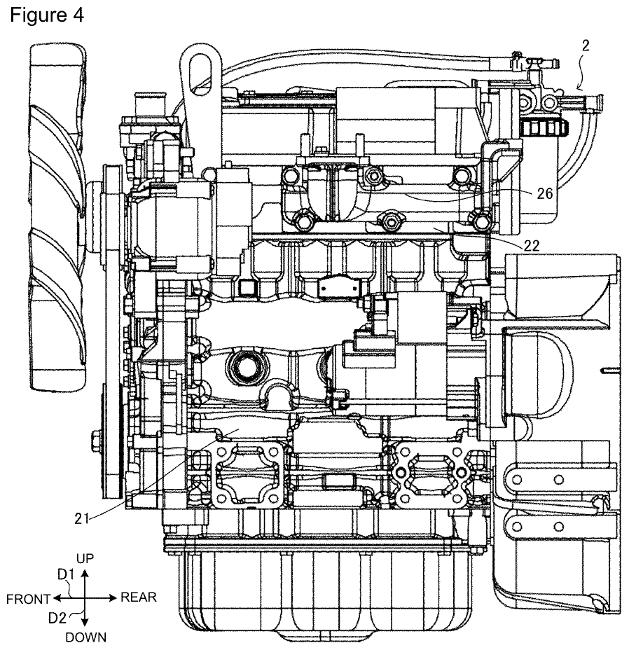

First, the entire configuration of an engine system 1 according to the present embodiment will be described with reference to FIGS. 1 to 4. FIG. 1 schematically shows the configuration of each part of the engine system 1, and shows the electrical connection relationship using long dashed short dashed line arrows (pointing in the flowing direction of electric signals).

The engine system 1 according to the present embodiment includes an engine body 2 that is a principal configuration of the engine system 1, as shown in FIG. 1. An “engine” described herein is a heat engine that generates mechanical energy (power) by combusting fuel, and includes an internal combustion engine that is a prime mover in which the combustion of fuel is performed inside the engine to convert thermal energy into mechanical energy using combustion gas as working gas. That is, the engine body 2 generates power (mechanical energy) using the supplied fuel.

The engine body 2 according to the present embodiment is a reciprocating engine that converts a reciprocating motion of a piston into a rotational motion and outputs a rotational force as power. In particular, in the present embodiment, a diesel engine that uses at least light oil as fuel, that is, a diesel reciprocating engine is described as an example of the engine body 2.

The engine system 1 is, for example, used in a mobile object, such as a work vehicle for various types of work, a marine vessel, or a flying object. Examples of the work vehicle include agricultural machines such as a tractor, a rice planting machine, and a combine harvester, and construction machines such as a backhoe (including a hydraulic excavator, a mini excavator, etc.), a wheel loader, and a carrier. The marine vessel includes a pleasure boat, a commercial ship including a cargo ship, a cargo-passenger ship, etc., a work ship including a tugboat, a salvage vessel, etc., a special ship including a weather ship, a training ship, etc., a fishing boat, and a naval vessel. The flying object includes a drone, a multicopter, or the like.

The engine system 1 is mounted on an object body of the mobile object. That is, the mobile object according to the present embodiment includes the engine system 1, and the object body. The engine system 1 is used as a drive source for generating a propulsive force that propels the object body and/or a driving force that drives a work machine, etc. In the present embodiment, the engine system 1 can further be used as a drive source for driving a generator that generates electric energy (electric power) used in the object body. That is, the engine system 1 is used as the drive source for generating the propulsive force and/or the driving force for the object body of the mobile object or for driving the generator. The electric energy generated by the generator may be stored in an energy storage device.

In the present embodiment, as an example, the engine system 1 is used in a tractor used for work in an agricultural field. The tractor is a type of work vehicle that travels in an agricultural field using power generated by the engine system 1. The tractor generates the propulsive force for moving the object body forward or backward by driving rear wheels that are the drive wheels using the power generated by the engine system 1.

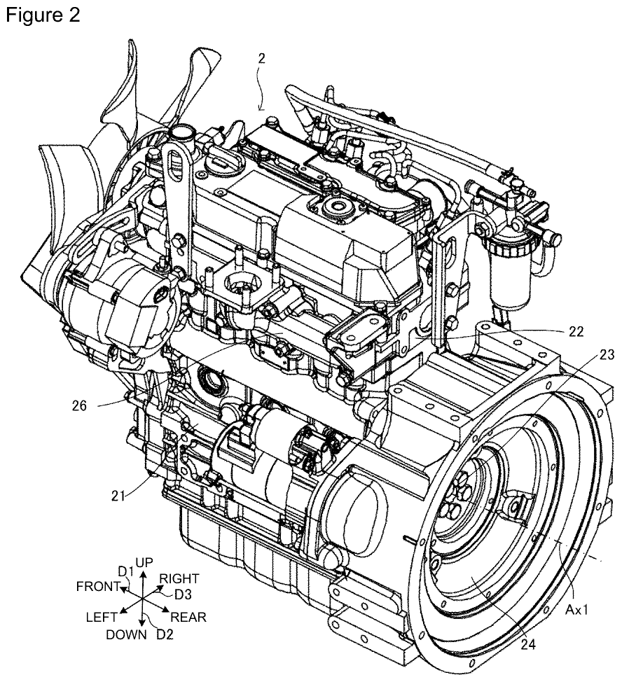

The engine body 2 is, for example, installed inside a hood of the object body of the tractor. Here, as shown in FIGS. 2 to 4, the engine body 2 is disposed in an orientation in which a cylinder block 21 and a cylinder head 22 are stacked in an up-down direction D2. Specifically, the engine body 2 is disposed in an orientation such that the cylinder head 22 is located above the cylinder block 21 and a rotation axis Ax1 of a crankshaft 23 is aligned with a substantially horizontal direction.

In addition, in the present embodiment, the mobile object (tractor) on which the engine system 1 is mounted is configured to operate in response to an operation (including a remote operation) performed by a person (operator), and is, specifically, a manned type in which the person as the operator can ride. Thus, the mobile object includes, on the object body, an operation device that receives the operation of the operator. In response to the operation on the operation device, a control unit 11 (refer to FIG. 1) of the engine system 1 drives the engine body 2. This enables the mobile object to move the object body forward or backward by rotating the drive wheels by driving the engine body 2 in response to the operation of the operator.

In addition, in the present embodiment, for the sake of description, as shown in FIG. 2, a direction along the rotation axis Ax1 of the crankshaft 23 is defined as an output shaft direction D1. Furthermore, as shown in FIG. 2, the direction that is perpendicular to the output shaft direction D1 and along the vertical direction in a state in which the engine body 2 is usable is defined as the up-down direction D2, and a direction perpendicular to both the output shaft direction D1 and the up-down direction D2 is defined as a width direction D3. Here, one side in the output shaft direction D1 is defined as a “front side”, and the other side thereof is defined as a “rear side”, and a side on which a flywheel 24 is disposed on the crankshaft 23 is defined as the rear side. Similarly, one side in the width direction D3 is defined as a “left side”, and the other side thereof is defined as a “right side” . Furthermore, in the up-down direction D2, a side on which the cylinder head 22 is located as viewed from the cylinder block 21 is defined as an “upper side”, and a side opposite thereto is defined as a “lower side”.

In other words, each direction used in the present embodiment is defined relative to the rotation axis Ax1 of the crankshaft 23. However, none of these directions are intended to limit the use direction (direction when used) of the engine body 2.

In the engine body 2, the rotational force of the crankshaft 23 serving as an engine output shaft is extracted as an output. The drive wheels and the like are coupled to the crankshaft 23 through a transmission device and the like. When the engine body 2 is driven and the crankshaft 23 rotates about the rotation axis Ax1, the drive wheels rotate, which enables the tractor to travel.

The engine system 1 according to the present embodiment is a diesel engine as described above. Thus, the engine body 2 is configured to allow fuel (here, light oil) to be supplied thereto from the outside of the engine body 2. That is, as shown in FIG. 1, the engine system 1 includes a fuel supply apparatus 3 for supplying fuel.

In addition, the engine system 1 according to the present embodiment further includes the control unit 11, as shown in FIG. 1. That is, the engine system 1 includes the fuel supply apparatus 3 and the control unit 11, in addition to the engine body 2.

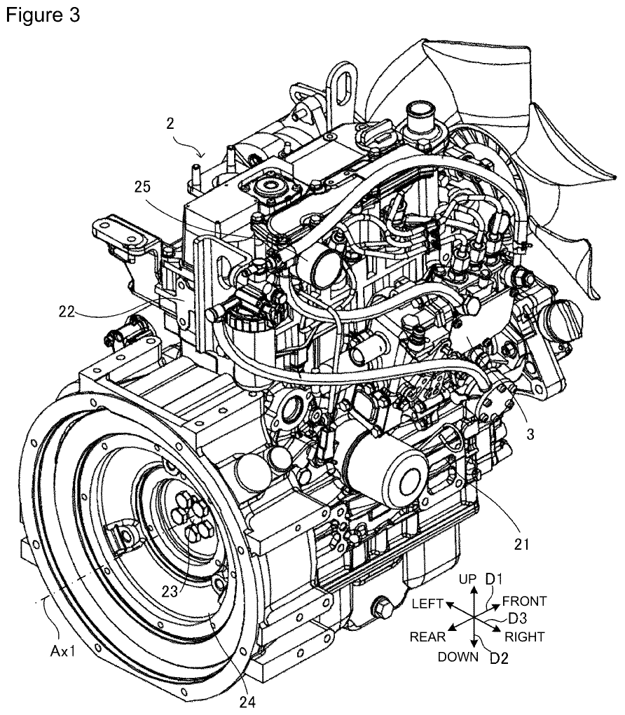

The engine body 2 is configured by assembling the cylinder head 22 to the top of the cylinder block 21, as shown in FIGS. 2 to 4. The cylinder block 21 includes a cylinder and a crank chamber. The cylinder head 22 includes an intake port and an exhaust port. As shown in FIGS. 2 and 3, the crankshaft 23 is rotatably supported on the cylinder block 21 with the rotation axis Ax1 aligned with the output shaft direction D1.

A plurality of cylinders are formed in the cylinder block 21 in such a manner that the cylinders are arranged in a line (in series) along the rotation axis Ax1 of the crankshaft 23. That is, in the present embodiment, the engine body 2 is an in-line multi-cylinder engine with the cylinders arranged in series. The output shaft direction D1 along the rotation axis Ax1 of the crankshaft 23 coincides with the arrangement direction of the cylinders. In each cylinder, a piston is housed slidably, that is, reciprocatably in the up-down direction D2. The piston is coupled to the crankshaft 23 through a connecting rod.

The cylinder head 22 is fixed above the cylinder block 21 so as to cover the cylinders from above. In an internal space of each cylinder, a space enclosed by an upper face of the piston and a lower face of the cylinder head 22 functions as a combustion chamber. That is, by the piston reciprocating in the up-down direction D2, the combustion chamber alternately repeats expansion and contraction.

For example, the cylinder head 22 is equipped with a valve train including a push rod, a rocker arm, and the like for operating an intake valve and an exhaust valve. The intake valve opens and closes an opening connected to the combustion chamber in the intake port formed in the cylinder head 22. The exhaust valve opens and closes an opening connected to the combustion chamber in the exhaust port formed in the cylinder head 22. Accordingly, in a state in which the intake valve is open, air (intake air) from the intake port can be drawn into the combustion chamber. In a state in which the exhaust valve is open, exhaust gas from the combustion chamber can be discharged to the exhaust port.

In addition, the engine body 2 includes an intake manifold 25 for distributing and supplying air (intake air) from the outside of the engine body 2 to the inside of the engine body 2 (the combustion chamber of each cylinder). Furthermore, the engine body 2 includes an exhaust manifold 26 for collecting exhaust gas generated by combustion in the combustion chamber of each cylinder and discharging the collected exhaust gas to the outside of the engine body 2.

The intake manifold 25 is disposed on the right side of the cylinder head 22, as shown in FIG. 3. The intake manifold 25 extends in the output shaft direction D1 and is connected to a plurality of intake ports formed in the cylinder head 22. Accordingly, air is distributed from the intake manifold 25 to the intake ports. That is, the intake manifold 25 communicates with the combustion chamber of each cylinder through the intake port.

The exhaust manifold 26 is disposed on the left side of the cylinder head 22, as shown in FIG. 2. The exhaust manifold 26 extends in the output shaft direction D1 and is connected to a plurality of exhaust ports formed in the cylinder head 22. Accordingly, exhaust gas from the exhaust ports is collected into the exhaust manifold 26. That is, the exhaust manifold 26 communicates with the combustion chamber of each cylinder through the exhaust port.

Here, the principal components constituting the engine body 2, such as the cylinder block 21, the cylinder head 22, the intake manifold 25, and the exhaust manifold 26, are made of, for example, a metal material such as an aluminum alloy or cast iron. These principal components have desired durability (including rigidity, wear resistance, etc.) and have relatively excellent thermal conductivity.

With the above configuration, when the engine body 2 is being driven, fuel is injected into the combustion chamber from the fuel supply apparatus 3 at an appropriate timing when air supplied to each cylinder from the intake manifold 25 is compressed by a slide of the piston. The injection of the fuel into the combustion chamber causes the piston to reciprocate inside the cylinder due to a propulsive force obtained from explosion that occurs in the combustion chamber, and the reciprocating motion of the piston is converted into a rotational motion of the crankshaft 23 through the connecting rod. Accordingly, the engine body 2 outputs the rotational force of the crankshaft 23 as power (mechanical energy).

In addition, when the engine body 2 is being driven, exhaust gas generated by combustion (explosion) in the combustion chamber is pushed out of the cylinder due to the motion of the piston, collected into the exhaust manifold 26 through the exhaust port, and then discharged to the outside of the engine body 2.

The fuel supply apparatus 3 includes an injection portion connected to a fuel tank through a fuel supply passage. The fuel supply apparatus 3 injects fuel supplied through the fuel supply passage into the engine body 2 from the injection portion having a nozzle shape (tubular shape). Here, the injection portion is disposed at a position facing the combustion chamber. This allows the injection portion to directly inject the fuel into the combustion chamber.

In the present embodiment, a junction on the intake manifold 25 with an intake channel 27 is an intake port 201, and a junction on the exhaust manifold 26 with an exhaust channel 28 is an exhaust port 202. That is, the engine body 2 draws in air through the intake channel 27 for drawing air into the intake manifold 25 and discharges air (exhaust gas) through the exhaust channel 28 connected to the exhaust manifold 26. Thick line arrows in FIG. 1 indicate the flow (airflow) of air (including intake air and exhaust gas).

The control unit 11 includes, as a principal configuration, a computer system including one or more processors such as central processing units (CPUs), and one or more memories such as a read only memory (ROM) and a random access memory (RAM), and executes various processes (information processing). In the one or more memories in the control unit 11, a program (engine control program) for causing the one or more processors to execute an engine control method is recorded.

The control unit 11 outputs control signals (electric signals) to the engine body 2, the fuel supply apparatus 3, and the like, and controls the engine body 2, the fuel supply apparatus 3, and the like. This enables the control unit 11, for example, to control the engine body 2 in such a manner as to adjust the output of the engine body 2 (mainly, the rotation speed) to any value.

Incidentally, the engine system 1 according to the present embodiment further includes various sensors 12 (refer to FIG. 1) and the like, in addition to the above-mentioned configuration (the engine body 2, the fuel supply apparatus 3, and the control unit 11).

The sensors 12 include a rotation speed sensor that detects the rotation speed of the engine body 2, a temperature sensor that measures the temperature of exhaust gas, etc., and a pressure sensor that measures the pressure of exhaust gas, etc. Each of the sensors 12 outputs an electric signal corresponding to a measured value (such as the rotation speed, the temperature, or the pressure) to the control unit 11.

### [2] Details of Fuel Supply Apparatus

Next, the details of the fuel supply apparatus 3 according to the present embodiment will be described with reference to FIGS. 3, 5, and 6.

The fuel supply apparatus 3 is an apparatus that supplies fuel stored in the fuel tank to the engine body 2 through the fuel supply passage. In the present embodiment, as an example, the fuel supply apparatus 3 is mounted on one side (e.g., the right side) of the engine body 2 in the width direction D3 (refer to FIG. 3). However, the position of the fuel supply apparatus 3 is not limited to the one side of the engine body 2 in the width direction D3, and it is also not essential that the fuel supply apparatus 3 be mounted on the engine body 2.

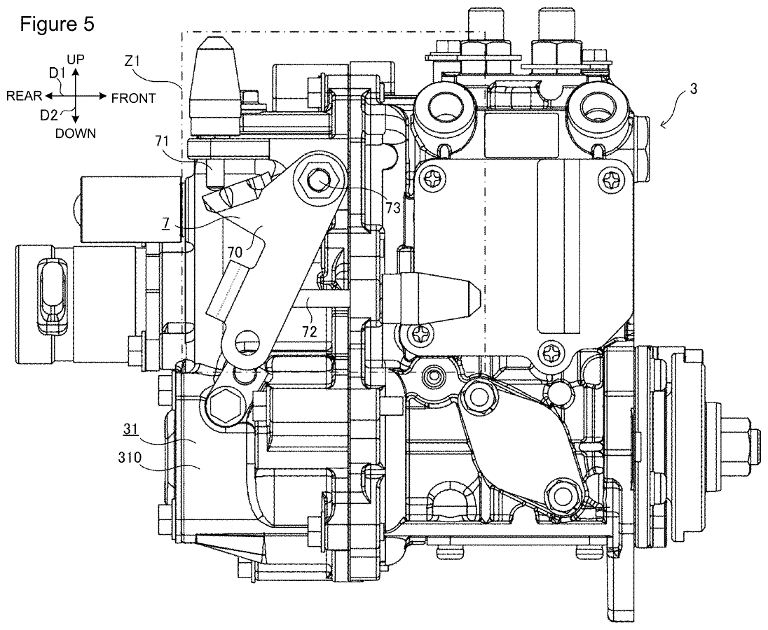

The fuel supply apparatus 3 includes a fuel injection pump 31 and a governor mechanism 7, as shown in FIG. 5. The fuel injection pump 31 is connected to the fuel tank through the fuel supply passage, and pressure-feeds the fuel stored in the fuel tank to the injection portion. Accordingly, the fuel is supplied to the engine body 2 in such a manner that the fuel is injected into (the combustion chamber of) the engine body 2 from an injection nozzle serving as the injection portion.

The governor mechanism 7 is a mechanical mechanism (mechanical governor) that adjusts the output (mainly, the rotation speed) of the engine body 2 by adjusting the supply amount of fuel to the engine body 2. The governor mechanism 7 adjusts the supply amount of fuel (fuel supply amount) to the engine body 2 by adjusting the amount of fuel pressure-fed by the fuel injection pump 31.

Specifically, as shown in FIG. 5, the governor mechanism 7 includes a lever member 70, and adjustment portions 71, 72. In the present embodiment, the governor mechanism 7 including the lever member 70 and the adjustment portions 71, 72, is mounted on a body 310 of the fuel injection pump 31. The body on which the governor mechanism 7 is mounted is not limited to the body 310 of the fuel injection pump 31 and may be a body other than the body 310 of the fuel injection pump 31, such as a dedicated body.

The lever member 70 is supported on the body 310 in a state in which the lever member 70 is rotatable about a shaft 73. The lever member 70 is coupled, through the shaft 73, to an operation element that increases and reduces the fuel supply amount in the fuel injection pump 31. That is, by the lever member 70 rotating relative to the body 310, the rotation of the lever member 70 is transmitted to the operation element of the fuel injection pump 31 through the shaft 73, thereby increasing or reducing the fuel supply amount in the fuel injection pump 31.

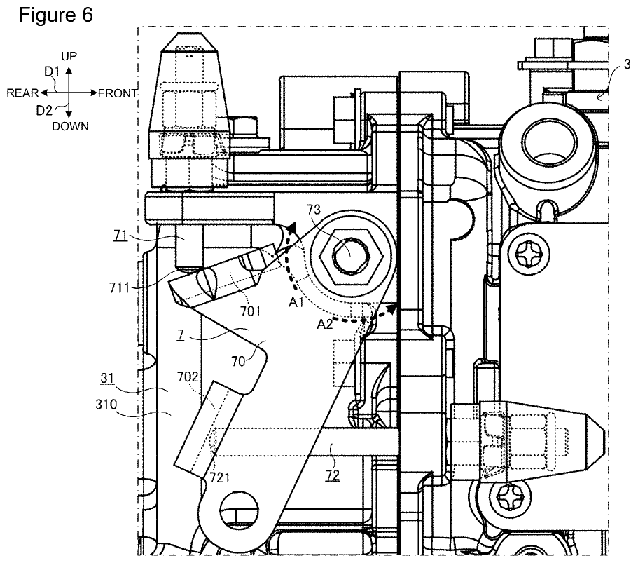

In the present embodiment, as an example, the front view of the fuel supply apparatus 3 mounted on the right side of the engine body 2 corresponds to the right side view of the engine body 2. As shown in FIG. 6, when the fuel supply apparatus 3 is viewed from the right side, the shaft 73 has a length in the width direction D3 that corresponds to the depth direction, and the lever member 70 is rotatable in a clockwise direction A1 and a counterclockwise direction A2 about the shaft 73.

In the present embodiment, in FIG. 6, the fuel supply amount in the fuel injection pump 31 increases when the lever member 70 rotates in the clockwise direction A1, and the fuel supply amount in the fuel injection pump 31 decreases when the lever member 70 rotates in the counterclockwise direction A2. Thus, a movable range of the lever member 70 in the clockwise direction A1 defines an upper limit of the fuel supply amount, which in turn defines an upper limit of the output (mainly, the rotation speed) of the engine body 2. On the contrary, a movable range of the lever member 70 in the counterclockwise direction A2 defines a lower limit of the fuel supply amount, which in turn defines a lower limit of the output (mainly, the rotation speed) of the engine body 2.

The adjustment portion 71, 72 is tightened and fixed to the body 310. The adjustment portion 71, 72 adjusts at least one of the upper limit and the lower limit of the supply amount of fuel to the engine body 2 in accordance with an amount of tightening relative to the body 310. In the present embodiment, the governor mechanism 7 includes two adjustment portions 71, 72. Hereinbelow, when the two adjustment portions 71, 72 are distinguished from each other, the adjustment portions 71, 72 may be referred to as a “first adjustment portion 71” and a “second adjustment portion 72”, respectively.

In the present embodiment, each of the adjustment portions 71, 72 is an adjustment bolt composed of a threaded rod (also called a “continuous thread rod” or a “full thread rod”). That is, each of the adjustment portions 71, 72 is a “male screw” that has a length and has threads formed on its outer peripheral face along the entire length in the length direction. Each of the adjustment portions 71, 72 is fixed to the body 310 in a state in which each of the adjustment portions 71, 72 is tightened into a threaded hole (female threads) formed in the body 310.

Here, specifically, the threaded rod serving as the first adjustment portion 71 has a length along the up-down direction D2, and is fixed to the body 310 above the lever member 70 in a state in which the threaded rod abuts against a first contact piece 701 (refer to FIG. 6) of the lever member 70 from above. The threaded rod serving as the second adjustment portion 72 has a length along the output shaft direction D1, and is fixed to the body 310 in front of the lever member 70 in a state in which the threaded rod abuts against a second contact piece 702 (refer to FIG. 6) of the lever member 70 from the front side.

The first adjustment portion 71 restricts the rotation of the lever member 70 in the clockwise direction A1 by bringing a contact-side end portion 711 (refer to FIG. 6) that is an end portion (lower end portion) of the lever member 70 in the longitudinal direction (up-down direction D2) into contact with the first contact piece 701 of the lever member 70. That is, the first adjustment portion 71 defines the upper limit of the fuel supply amount by limiting the movable range of the lever member 70 in the clockwise direction A1, and in turn defines the upper limit of the output (mainly, the rotation speed) of the engine body 2.

The second adjustment portion 72 restricts the rotation of the lever member 70 in the counterclockwise direction A2 by bringing a contact-side end portion 721 (refer to FIG. 6) that is an end portion (rear end portion) of the lever member 70 in the longitudinal direction (output shaft direction D1) into contact with the second contact piece 702 of the lever member 70. That is, the second adjustment portion 72 defines the lower limit of the fuel supply amount by limiting the movable range of the lever member 70 in the counterclockwise direction A2, and in turn defines the lower limit of the output (mainly, the rotation speed) of the engine body 2.

The position of the contact-side end portion 711 of the first adjustment portion 71 in the longitudinal direction (up-down direction D2) can be adjusted by the amount of tightening of the first adjustment portion 71 relative to the body 310. Thus, by adjusting the amount of tightening of the first adjustment portion 71 relative to the body 310, it is possible to limit the movable range of the lever member 70 in the clockwise direction A1 and adjust the upper limit of the output of the engine body 2. For example, by moving the contact-side end portion 711 downward by adjusting the amount of tightening of the first adjustment portion 71, it is possible to narrow the movable range of the lever member 70 in the clockwise direction A1 and reduce the upper limit of the output of the engine body 2.

Similarly, the position of the contact-side end portion 721 of the second adjustment portion 72 in the longitudinal direction (output shaft direction D1) can be adjusted by the amount of tightening of the second adjustment portion 72 relative to the body 310. Thus, by adjusting the amount of tightening of the second adjustment portion 72 relative to the body 310, it is possible to limit the movable range of the lever member 70 in the counterclockwise direction A2 and adjust the lower limit of the output of the engine body 2. For example, by moving the contact-side end portion 721 rearward by adjusting the amount of tightening of the second adjustment portion 72, it is possible to narrow the movable range of the lever member 70 in the counterclockwise direction A2 and increase the lower limit of the output of the engine body 2.

As described above, the governor mechanism 7 is configured in such a manner that the movable range of the lever member 70 can be adjusted by the adjustment portion 71, 72. At least one of the movable ranges of the lever member 70 in the clockwise direction A1 and the counterclockwise direction A2 is adjusted in accordance with the amount of tightening of the adjustment portion 71, 72 relative to the body 310. As a result, at least one of the upper limit and the lower limit of the output of the engine body 2 is adjusted. In this manner, the governor mechanism 7 mechanically defines the upper limit and/or the lower limit of the fuel supply amount by providing a limitation on the movable range of the lever member 70, thereby defining the upper limit and/or the lower limit of the output (mainly, the rotation speed) of the engine body 2. The upper limit and/or the lower limit is adjustable in accordance with the amount of tightening of the adjustment portion 71, 72 relative to the body 310.

In the present embodiment, the first adjustment portion 71 is a “high idle bolt” that defines the upper limit (a limit value on the high rotation speed side) of the output of the engine body 2, and the second adjustment portion 72 is a “low idle bolt” that defines the lower limit (a limit value on the low rotation speed side) of the output of the engine body 2. Thus, the governor mechanism 7 can define both the upper limit and the lower limit of the output of the engine body 2, and can individually adjust the upper limit and the lower limit of the output of the engine body 2 in accordance with the amount of tightening of each of the first adjustment portion 71 and the second adjustment portion 72.

### [3] Details of Governor Mechanism

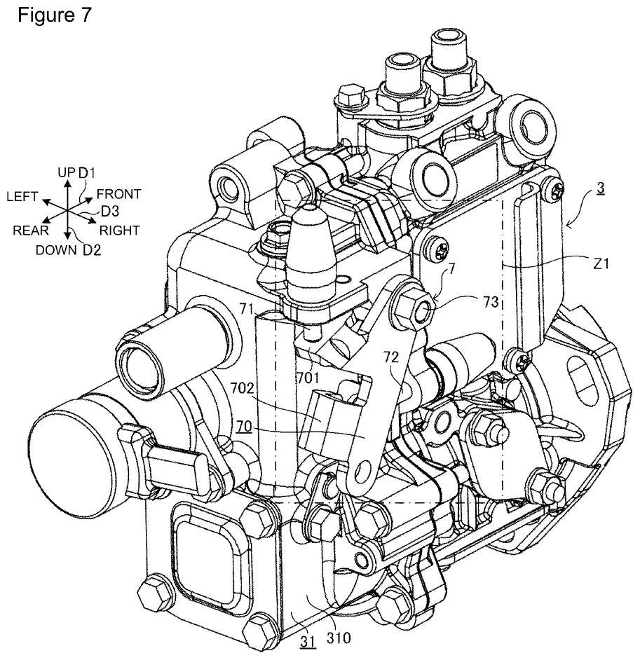

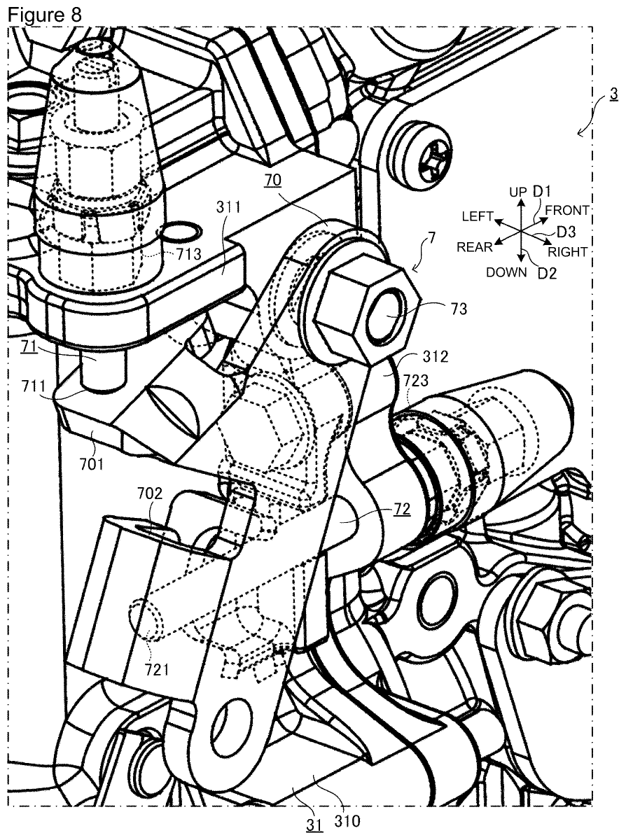

Next, the details of the governor mechanism 7 according to the present embodiment will be described with reference to FIGS. 7 and 8.

The lever member 70 and the adjustment portions 71, 72 that are the components of the governor mechanism 7 are all made of a metal material such as an aluminum alloy or cast iron. These components have desired durability (including rigidity, wear resistance, etc.). In particular, the lever member 70 is made of a metal plate having a predetermined thickness.

The lever member 70 has a length and is supported on the body 310 through the shaft 73 in such a manner that the shaft 73 penetrates one end portion in the longitudinal direction (the upper end portion in the example of FIG. 7). Accordingly, the lever member 70 is supported on the body 310 in a state in which the lever member 70 is rotatable about the one end portion (upper end portion) in the longitudinal direction where the shaft 73 is located.

The lever member 70 integrally includes the first contact piece 701 and the second contact piece 702. That is, the lever member 70 made of a metal plate includes a part that is bent to constitute the first contact piece 701 and another part that is bent to constitute the second contact piece 702. In the present embodiment, the first contact piece 701 is located at an intermediate portion of the lever member 70 in the longitudinal direction, and the second contact piece 702 is located at the other end portion in the longitudinal direction (the lower end portion in the example of FIG. 7). That is, the first contact piece 701 and the second contact piece 702 are disposed at different positions in the longitudinal direction of the lever member 70.

In the present embodiment, both the first contact piece 701 and the second contact piece 702 project toward the body 310 side (leftward) in the width direction D3 from a side edge portion of the lever member 70 pointing in the clockwise direction A1 (refer to FIG. 6). The movable range of the lever member 70 in the clockwise direction A1 is limited by bringing the first contact piece 701 into contact with the contact-side end portion 711 of the first adjustment portion 71 from below. On the other hand, the movable range of the lever member 70 in the counterclockwise direction A2 is limited by bringing the second contact piece 702 into contact with the contact-side end portion 721 of the second adjustment portion 72 from the rear side.

The first adjustment portion 71 is tightened and fixed to a first retaining piece 311 of the body 310, as shown in FIG. 8. The first retaining piece 311 is a plate-shaped portion having a thickness in the up-down direction D2 and projects rightward from a right side face of the body 310. The first retaining piece 311 has a through hole that penetrates the first retaining piece 311 in the thickness direction (up-down direction D2). The through hole has threads (female threads) formed on its inner peripheral face, and constitutes a threaded hole into which the first adjustment portion 71 is tightened. That is, the first adjustment portion 71 is fixed to the body 310 in such a manner as to penetrate the first retaining piece 311 in the thickness direction (up-down direction D2).

In the first adjustment portion 71, an end portion (lower end portion) located on the lever member 70 side as viewed from the first retaining piece 311 in the longitudinal direction (up-down direction D2) is defined as the contact-side end portion 711, and the contact-side end portion 711 faces the first contact piece 701 of the lever member 70. With this configuration, a (downward) projecting amount of the contact-side end portion 711 as viewed from the first retaining piece 311 changes in accordance with the amount of tightening of the first adjustment portion 71 relative to the first retaining piece 311.

As shown in FIG. 8, the first adjustment portion 71 has a fixing nut 713 fastened to a part on the side opposite to the lever member 70 in the longitudinal direction (up-down direction D2) as viewed from the first retaining piece 311. The fixing nut 713 fixes the first adjustment portion 71 to the first retaining piece 311. Specifically, the fixing nut 713 constitutes a double nut structure together with the first retaining piece 311, and the first adjustment portion 71 is prevented from being loosened from the first retaining piece 311 by tightening the fixing nut 713 with the first adjustment portion 71 penetrating the first retaining piece 311. Thus, in a state in which the fixing nut 713 is tightened, the amount of tightening of the first adjustment portion 71 relative to (the first retaining piece 311 of) the body 310 is fixed.

The second adjustment portion 72 is tightened and fixed to a second retaining piece 312 of the body 310, as shown in FIG. 8. The second retaining piece 312 is a plate-shaped portion having a thickness in the output shaft direction D1 and projects rightward from the right side face of the body 310. The second retaining piece 312 has a through hole that penetrates the second retaining piece 312 in the thickness direction (output shaft direction D1). The through hole has threads (female threads) formed on its inner peripheral face, and constitutes a threaded hole into which the second adjustment portion 72 is tightened. That is, the second adjustment portion 72 is fixed to the body 310 in such a manner as to penetrate the second retaining piece 312 in the thickness direction (output shaft direction D1).

In the second adjustment portion 72, an end portion (rear end portion) located on the lever member 70 side as viewed from the second retaining piece 312 in the longitudinal direction (output shaft direction D1) is defined as the contact-side end portion 721, and the contact-side end portion 721 faces the second contact piece 702 of the lever member 70. With this configuration, a (rearward) projecting amount of the contact-side end portion 721 as viewed from the second retaining piece 312 changes in accordance with the amount of tightening of the second adjustment portion 72 relative to the second retaining piece 312.

As shown in FIG. 8, the second adjustment portion 72 has a fixing nut 723 fastened to a part on the side opposite to the lever member 70 in the longitudinal direction (output shaft direction D1) as viewed from the second retaining piece 312. The fixing nut 723 fixes the second adjustment portion 72 to the second retaining piece 312. Specifically, the fixing nut 723 constitutes a double nut structure together with the second retaining piece 312, and the second adjustment portion 72 is prevented from being loosened from the second retaining piece 312 by tightening the fixing nut 723 with the second adjustment portion 72 penetrating the second retaining piece 312. Thus, in a state in which the fixing nut 723 is tightened, the amount of tightening of the second adjustment portion 72 relative to (the second retaining piece 312 of) the body 310 is fixed.

In addition, the governor mechanism 7 further includes caps 74, 75. The caps 74, 75 are members attached to one end portion of the adjustment portions 71, 72, respectively, in the longitudinal direction.

The cap 74 is attached to a part of the first adjustment portion 71 on the side opposite to the lever member 70 as viewed from the first retaining piece 311. The cap 74 has a bottomed tubular shape. In a state in which the cap 74 is attached to the first adjustment portion 71, the cap 74 covers, together with the fixing nut 713, the part of the first adjustment portion 71 on the side opposite to the lever member 70 as viewed from the first retaining piece 311.

The cap 75 is attached to a part of the second adjustment portion 72 on the side opposite to the lever member 70 as viewed from the second retaining piece 312. The cap 75 has a bottomed tubular shape. In a state in which the cap 75 is attached to the second adjustment portion 72, the cap 75 covers, together with the fixing nut 723, the part of the second adjustment portion 72 on the side opposite to the lever member 70 as viewed from the second retaining piece 312.

That is, in a state in which the cap 74 is attached, the fixing nut 713 cannot be loosened, and a change in the amount of tightening of the first adjustment portion 71 relative to the body 310, detachment of the first adjustment portion 71, and the like cannot be performed. Similarly, in a state in which the cap 75 is attached, the fixing nut 723 cannot be loosened, and a change in the amount of tightening of the second adjustment portion 72 relative to the body 310, detachment of the second adjustment portion 72, and the like cannot be performed.

Since the caps 74, 75 have the function of preventing tampering with the adjustment portions 71, 72 through illegal modification, the caps 74, 75 are a type of “tamper-resistant structure” as a countermeasure against illegal modification. Thus, the details of the caps 74, 75 will be described in the section of “[4] Tamper-resistant structure of governor mechanism”.

Incidentally, in the governor mechanism 7, as described above, by the lever member 70 contacting the adjustment portion 71, 72, the movable range of the lever member 70 is mechanically limited and the fuel supply amount is limited. Thus, if, for example, the lever member 70 and/or the adjustment portion 71, 72 is tampered with through illegal modification made by an end user, the functions required of the governor mechanism 7 may not be exhibited. As an example, if the first adjustment portion 71 is detached, the lever member 70 has no counterpart (the first adjustment portion 71) to contact when the lever member 70 rotates in the clockwise direction A1. Thus, the movable range of the lever member 70 in the clockwise direction A1 is not limited, and the fuel supply amount is not limited to the desired upper limit.

In the fuel supply apparatus 3 of the present embodiment, to prevent a situation where the governor mechanism 7 cannot exhibit the desired functions due to illegal modification, the “tamper-resistant structure” is adopted as a countermeasure against illegal modification for the purpose of enhancing resistance to illegal modification (tamper resistance).

### [4] Tamper-Resistant Structure of Governor Mechanism

Next, the tamper-resistant structure of the governor mechanism 7 according to the present embodiment will be described in detail.

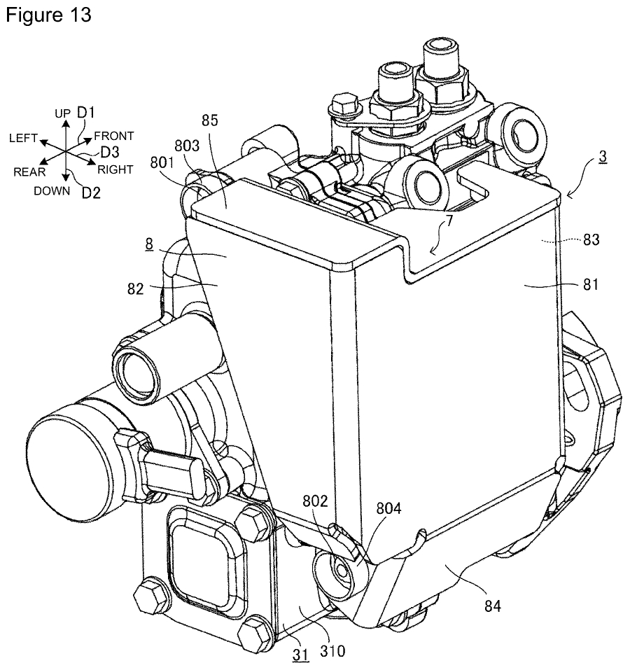

In the governor mechanism 7 according to the present embodiment, the tamper-resistant structure broadly includes three types of tamper-resistant structures: a tamper-resistant structure using the caps 74, 75; a tamper-resistant structure using the lever member 70; and a tamper-resistant structure using a cover member 8 (refer to FIG. 13). In the present embodiment, although all of the three types of tamper-resistant structures are adopted, this is not a limitation. Only one type may be adopted, or an appropriate combination of two types may be adopted.

Hereinbelow, the three types of tamper-resistant structures will be described in order.

### [4.1] Tamper-Resistant Structure Using Caps

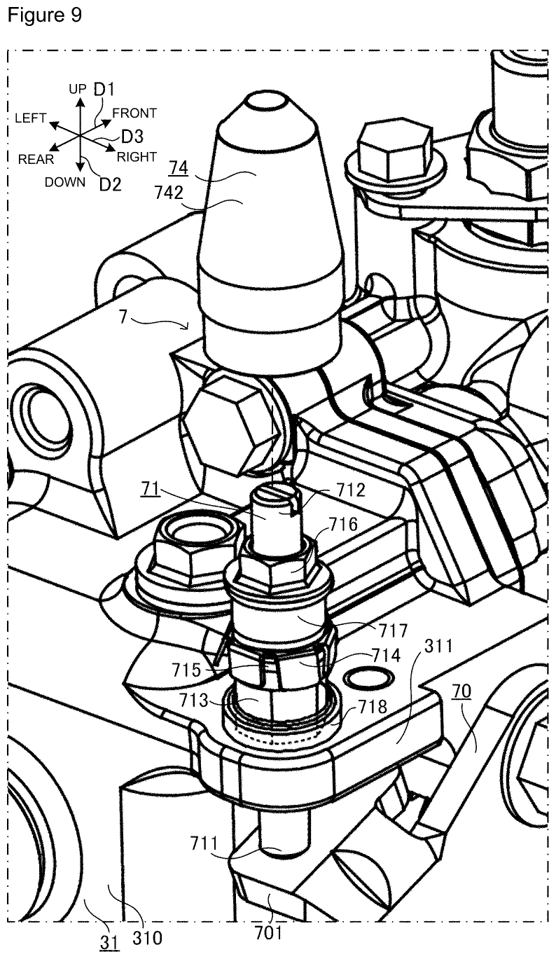

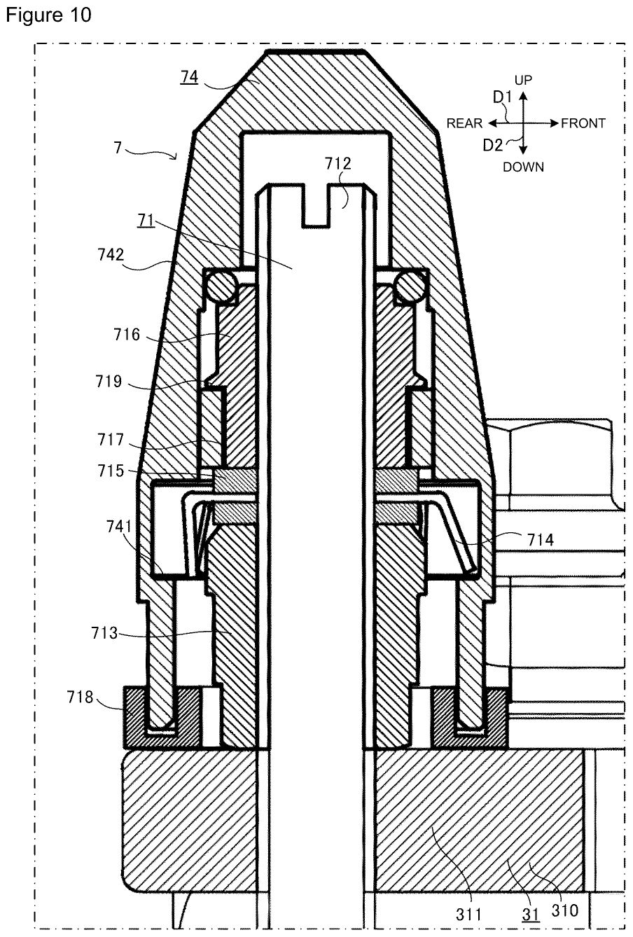

First, the tamper-resistant structure using the caps 74, 75 will be described with reference to FIGS. 9 and 10.

In the present embodiment, the cap 74 attached to the first adjustment portion 71 and the cap 75 attached to the second adjustment portion 72 basically adopt a common configuration. Thus, in the following, the cap 74 attached to the first adjustment portion 71 will be described in detail, and detailed description of the cap 75 attached to the second adjustment portion 72 is omitted because the same configuration is adopted.

The cap 74 is attached to a tip portion 712 side of the adjustment portion 71 so as to cover the tip portion 712. The tip portion 712 of the adjustment portion 71 is an end portion (upper end portion) of the adjustment portion 71 on the side opposite to the contact-side end portion 711 in the longitudinal direction (up-down direction D2). Here, the cap 74 covers the whole of a part of the adjustment portion 71 that projects from the first retaining piece 311 to the side opposite to the lever member 70 (tip portion 712 side) so as to cover the adjustment portion 71 from the tip portion 712 to the fixing nut 713.

In this manner, the cap 74 is an example of a sealing portion that prevents illegal modification made by an end user to the adjustment portion 71 by sealing the part of the adjustment portion 71 projecting from the first retaining piece 311 to the side opposite to the lever member 70. That is, in a state in which the cap 74 is attached, the adjustment portion 71 cannot be tightened to or loosened from (the first retaining piece 311 of) the body 310, and the adjustment portion 71 cannot be detached from (the first retaining piece 311 of) the body 310. As a result, the cap 74 makes it possible to restrict a change in the amount of tightening of the adjustment portion 71 relative to the body 310.

Specifically, the cap 74 has a bottomed tubular shape and is attached to the adjustment portion 71 in a manner in which the one end portion (tip portion 712) of the adjustment portion 71 in the longitudinal direction is inserted in the cap 74. In the present embodiment, the cap 74 is a bottomed cylindrical component that has a bottom on the tip end portion 712 side (upper end side) of the adjustment portion 71 in the longitudinal direction (up-down direction D2) and is open on the contact-side end portion 711 side (lower end side). The total length of the cap 74 is longer than the part of the adjustment portion 71 projecting from the first retaining piece 311 to the side opposite to the lever member 70.

Furthermore, in the present embodiment, the cap 74 has a tapered surface 742 having an outer diameter that decreases toward the tip side (bottom side). That is, the cap 74 has an outer peripheral face including the tapered surface 742 in such a manner that the outer diameter is not constant in the longitudinal direction (up-down direction D2) but decreases toward the tip side. Thus, the cap 74 has a tapered shape.

In addition to the fixing nut 713, an elastic member 714, a holder 715, a nut 716, a collar 717, and a washer 718 are attached to the part of the adjustment portion 71 covered by the cap 74, that is, the part projecting from the first retaining piece 311 to the side opposite to the lever member 70. The fixing nut 713, the elastic member 714, the holder 715, the nut 716, the collar 717, and the washer 718 are all made of, for example, a metal material such as an aluminum alloy or cast iron. These components have desired durability (including rigidity, wear resistance, etc.). However, at least some of these components are not limited to be made of metal and may be made of, for example, resin.

The elastic member 714 held by the holder 715 is attached to the adjustment portion 71. The holder 715 is formed in an annular shape (ring shape). The holder 715 is attached to the adjustment portion 71 in such a manner that the adjustment portion 71 penetrates the holder 715. The inner diameter of the holder 715 is larger than the outer diameter of the adjustment portion 71. As shown in FIG. 10, in a state in which the cap 74 is attached, the holder 715 is disposed in a gap between an inner peripheral face of the cap 74 and an outer peripheral face of the adjustment portion 71.

The elastic member 714 is a leaf spring made of metal and is configured to extend outward from an outer peripheral face of the holder 715. The elastic member 714 is inclined obliquely downward. The elastic member 714 is elastically deformable in a direction of reducing its outer diameter due to its springiness.

Accordingly, when the cap 74 is attached to the adjustment portion 71 with the elastic member 714 attached, the elastic member 714 becomes elastically deformed in the direction of contraction, thereby enabling the cap 74 to be attached without obstructing the (downward) movement of the cap 74. On the other hand, when attempting to move the cap 74 attached to the adjustment portion 71 upward, the elastic member 714 catches on a step 741 (refer to FIG. 10) on the inner peripheral face of the cap 74, thereby obstructing the movement of the cap 74 in the direction of detaching the cap 74 (upward).

The nut 716 is tightened to the adjustment portion 71. The nut 716 is attached to the tip portion 712 side as viewed from the fixing nut 713. The fixing nut 713, the holder 715, and the nut 716 are attached to the adjustment portion 71 in this order from the first retaining piece 311 side. Thus, the elastic member 714 is fixed to the adjustment portion 71 by the holder 715 being sandwiched between the nut 716 and the fixing nut 713.

The collar 717 is formed in a cylindrical shape. The collar 717 is attached to the adjustment portion 71 in such a manner that the adjustment portion 71 penetrates the collar 717 together with the nut 716. The inner diameter of the collar 717 is substantially equal to the outer diameter of the nut 716. As shown in FIG. 10, in a state in which the cap 74 is attached, the collar 717 is disposed in a gap between the inner peripheral face of the cap 74 and an outer peripheral face of the nut 716.

That is, the collar 717 is interposed between the cap 74 and the nut 716. For example, when an external impact is applied to the cap 74, the impact is not directly transmitted from the cap 74 to the nut 716, but is transmitted through the collar 717. Thus, the impact is absorbed between the cap 74 and the collar 717, and also absorbed between the collar 717 and the nut 716. As a result, the impact transmitted to nut 716 can be relieved.

Furthermore, the nut 716 has a flange 719 that projects throughout the entire circumference from its outer peripheral face. The flange 719 has a larger diameter than a part of the nut 716 other than the flange 719. The collar 717 is sandwiched between the flange 719 and the holder 715 (or the elastic member 714) in the longitudinal direction of the adjustment portion 71 (up-down direction D2). Accordingly, the positioning of the collar 717 is performed, and the collar 717 is prevented from coming off the adjustment portion 71.

The washer 718 is formed in an annular shape (ring shape). The washer 718 is assembled with the adjustment portion 71 in such a manner that the adjustment portion 71 penetrates the washer 718 together with the fixing nut 713. The inner diameter of the washer 718 is larger than the outer diameter of the fixing nut 713. As shown in FIG. 10, in a state in which the cap 74 is attached, the washer 718 is disposed in a gap between an opening peripheral edge of the cap 74 and the first retaining piece 311. In the present embodiment, the washer 718 includes a groove on a face (upper face) on the tip portion 712 side in the up-down direction D2, and the opening peripheral edge of the cap 74 is inserted into the groove.

As described above, the fuel supply apparatus 3 according to the present embodiment includes the governor mechanism 7 that adjusts the output of the engine body 2. The governor mechanism 7 includes the adjustment portion 71, 72, and the sealing portion. The adjustment portion 71, 72 is tightened and fixed to the body 310, and adjusts at least one of the upper limit and the lower limit of the output of the engine body 2 in accordance with the amount of tightening relative to the body 310. The sealing portion restricts a change in the amount of tightening of the adjustment portion 71, 72.

In the present embodiment, the cap 74, 75 is an example of the sealing portion. The governor mechanism 7, by including the sealing portion, restricts a change in the amount of tightening of the adjustment portion 71, 72 relative to the body 310. That is, the end user cannot easily tighten or loosen the adjustment portion 71, 72 to or from the body 310 and cannot detach the adjustment portion 71, 72 from the body 310. Thus, the governor mechanism 7, by including the sealing portion as the tamper-resistant structure, can easily enhance resistance to illegal modification, particularly, to the adjustment portion 71, 72.

Here, the sealing portion includes the cap 74, 75. The cap 74, 75 has a bottomed tubular shape, is attached to the adjustment portion 71, 72 in a manner in which the one end portion of the adjustment portion 71, 72 in the longitudinal direction is inserted in the cap 74, 75, and is undetachable from the adjustment portion 71, 72 without destruction. The “one end portion” of the adjustment portion 71, 72 in the longitudinal direction is the part of the adjustment portion 71, 72 projecting from the body 310 (first retaining piece 311 or the second retaining piece 312) to the side opposite to the lever member 70 (tip portion 712 side), and also referred to as the “tip portion 712 side”.

That is, when attempting to detach the cap 74, 75, the elastic member 714 catches on the step 741 on the inner peripheral face of the cap 74, 75, thereby obstructing the movement of the cap 74, 75 in the direction of detaching the cap 74, 75. Thus, the cap 74, 75 is undetachable from the adjustment portion 71, 72 without destruction, and it is possible to prevent tampering with the adjustment portion 71, 72 through indiscriminate illegal modification. In particular, in the tamper-resistant structure using the cap 74, 75 according to the present embodiment, sufficient tamper resistance can be achieved even when the diameter of the adjustment portion 71, 72 is relatively small, and the adjustment portion 71, 72 is relatively vulnerable to an external impact.

The sealing portion further includes the collar 717. The collar 717 is disposed inside the cap 74, 75, and the one end portion (tip end portion 712 side) of the adjustment portion 71, 72 penetrates the collar 717. Accordingly, when an external impact is applied to the cap 74, 75, the impact is absorbed by the collar 717, and it is possible to restrain reduction in an axial force caused by the impact propagating from the cap 74, 75 to the nut 716.

Furthermore, in the present embodiment, the nut 716 provided at the one end portion (tip portion 712 side) of the adjustment portion 71, 72 in the longitudinal direction has the flange 719. The flange 719 restricts the movement of the collar 717 in the direction of coming off the adjustment portion 71, 72. This can prevent the collar 717 from coming off during assembly of the governor mechanism 7 (in particular, when the cap 74, 75 is attached) and contributes to improving assemblability.

In addition, the sealing portion further includes the washer 718 that fills the gap between the opening peripheral edge of the cap 74, 75 and the body 310. By providing such a washer 718, it is possible to restrain the cap 74, 75 from being broken and forcibly detached by prying the gap between the cap 74, 75 and the body 310 (the first retaining piece 311 or the second retaining piece 312).

In addition, in the present embodiment, the sealing portion includes the elastic member 714. The elastic member 714 is located inside the cap 74, 75 and is attached to the one end portion (tip end portion 712 side) of the adjustment portion 71, 72 in the longitudinal direction to prevent the cap 74, 75 from coming off the adjustment portion 71, 72. In this manner, by the elastic member 714 preventing the cap 74, 75 from coming off the adjustment portion 71, 72, it is possible to prevent the cap 74, 75 from being easily detached while making the attachment of the cap 74, 75 easy.

Furthermore, in the present embodiment, the cap 74, 75 has the tapered surface 742 having an outer diameter that decreases toward the tip side. Providing such a tapered surface 742 makes it difficult to grasp the cap 74, 75 even when, for example, a tool, such as pliers, is used, and makes it possible to restrain the cap 74, 75 from being broken and forcibly detached.

### [4.2] Tamper-Resistant Structure Using Lever Member

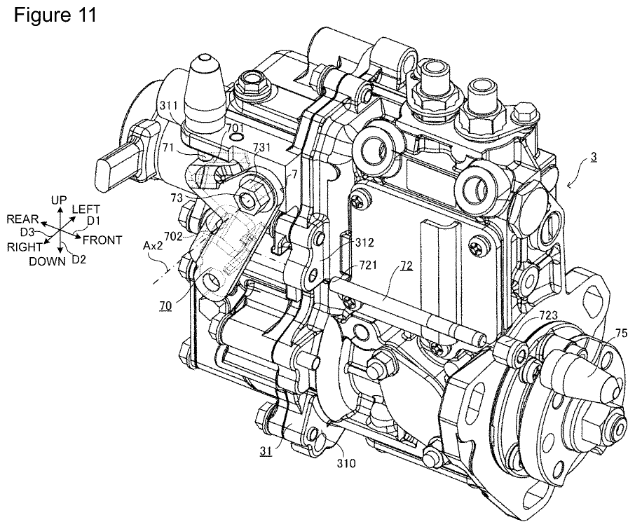

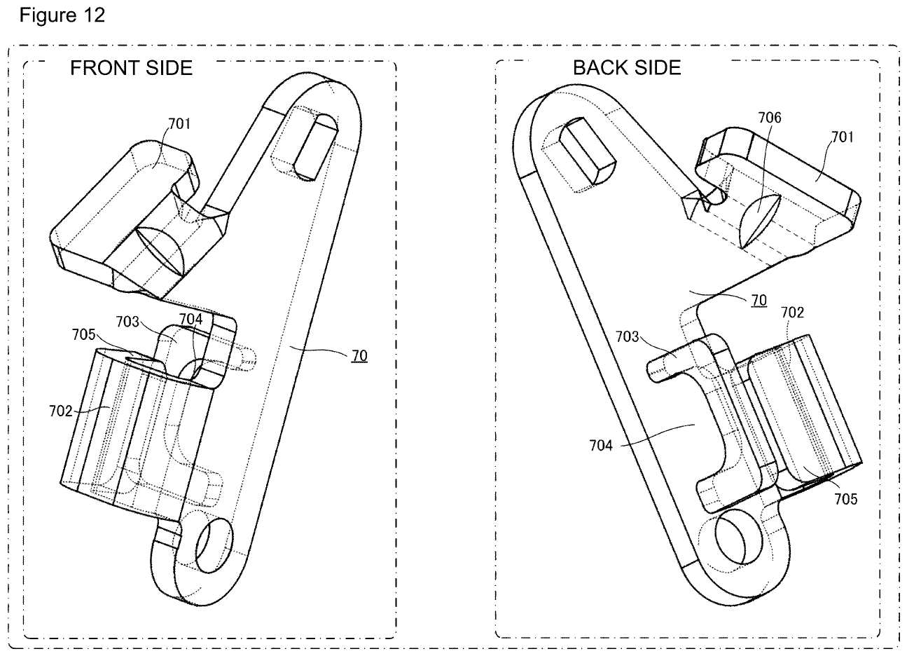

Next, the tamper-resistant structure using the lever member 70 will be described with reference to FIGS. 11 and 12.

In assembly of the governor mechanism 7, as shown in FIG. 11, after the lever member 70 is fixed to the body 310, the second adjustment portion 72 is attached to (the second retaining piece 312 of) the body 310. In a state in which the second adjustment portion 72 is attached to the body 310, the movement of the lever member 70 in a rotation axis Ax2 direction of the lever member 70 is restricted.

Here, since the lever member 70 is fixed to the shaft 73 with a lever nut 731, the lever member 70 is supported on the body 310 in a state in which the lever member 70 is rotatable about the rotation axis Ax2 that is the axis of the shaft 73. That is, the lever member 70 is attached to the shaft 73 from one side (right side) in the rotation axis Ax2 direction (width direction D3), and, in this state, is fixed by the lever nut 731 being tightened to the shaft 73. Thus, the attachment or detachment of the lever member 70 is performed by moving the lever member 70 in the rotation axis Ax2 direction (width direction D3) with the lever nut 731 detached.

In the present embodiment, in a state in which the second adjustment portion 72 is attached to the body 310, the movement of the lever member 70 in the rotation axis Ax2 direction is restricted. As a result, the detachment of the lever member 70 is restricted.

Specifically, as shown in FIG. 12, the lever member 70 further includes a first restriction portion 703, a second restriction portion 705, and a reinforcing rib 706, in addition to the first contact piece 701 and the second contact piece 702. The first restriction portion 703, the second restriction portion 705, and the reinforcing rib 706 are integrated with the other part of the lever member 70.

The first restriction portion 703 projects from a back face (in the present embodiment, the left side face) of the lever member 70, the back face facing the body 310. The first restriction portion 703 is a plate-shaped member having a thickness in the longitudinal direction of the second adjustment portion 72 and is joined to a part of the lever member 70 other than the first restriction portion 703 by, for example, joining means such as welding. The first restriction portion 703 is disposed at a position facing the second contact piece 702. The first restriction portion 703 has a through hole 704 that penetrates the first restriction portion 703 in the thickness direction (the longitudinal direction of the second adjustment portion 72).

When the second adjustment portion 72 is attached to the body 310, the second adjustment portion 72 is assembled with the lever member 70 in such a manner that the contact-side end portion 721 of the second adjustment portion 72 is brought into contact with the second contact piece 702 through the through hole 704 of the first restriction portion 703 in the lever member 70 in a state. That is, since the second adjustment portion 72 passes through the through hole 704 of the first restriction portion 703, the positional relationship between the lever member 70 and the second adjustment portion 72 is maintained by the first restriction portion 703. The through hole 704 is formed with a sufficiently larger dimension relative to the thickness of the second adjustment portion 72 so as not to obstruct the rotation of the lever member 70.

The second restriction portion 705 projects from a tip portion of the second contact piece 702 toward a base portion (the end portion on the side opposite to the contact-side end portion 721) side of the second adjustment portion 72. In the present embodiment, as an example, the second contact piece 702 is bent toward the body 310 side (leftward) along the rotation axis Ax2 direction, and its tip portion is further bent forward to constitute the second restriction portion 705.

Accordingly, the second restriction portion 705, together with the second contact piece 702, surrounds the contact-side end portion 721 of the second adjustment portion 72. Thus, the positional relationship between the lever member 70 and the second adjustment portion 72 is also maintained by the second restriction portion 705.

The reinforcing rib 706 is a rib that reinforces the first contact piece 701. In the present embodiment, as an example, the first contact piece 701 is bent toward the body 310 side (leftward) along the rotation axis Ax2 direction, and its bent portion is reinforced by the reinforcing rib 706.

As described above, the fuel supply apparatus 3 according to the present embodiment includes the governor mechanism 7 that adjusts the output of the engine body 2. The governor mechanism 7 includes the lever member 70 and the adjustment portion 71, 72. The lever member 70 is rotatably supported relative to the body 310. The adjustment portion 71, 72 adjusts the movable range of the lever member 70. Here, the lever member 70 includes a maintaining structure that maintains the positional relationship with the adjustment portion 71, 72.

In the present embodiment, the first restriction portion 703 and the second restriction portion 705 are examples of the maintaining structure. By the governor mechanism 7 having the maintaining structure, the positional relationship between the lever member 70 and the adjustment portion 71, 72 is maintained. That is, the end user cannot easily detach the lever member 70 from the body 310, and cannot bend and break the lever member 70. Thus, the governor mechanism 7, by having the maintaining structure as the tamper-resistant structure, can easily enhance resistance to illegal modification, particularly, to the lever member 70.

Here, the maintaining structure includes the first restriction portion 703. The first restriction portion 703 restricts the movement of the lever member 70 relative to the adjustment portion 72 in the rotation axis Ax2 direction of the lever member 70. The presence of such a first restriction portion 703 makes tampering with the lever member 70 difficult unless the adjustment portion 72 is detached and easily enhances resistance to illegal modification to the lever member 70.

The first restriction portion 703 restricts the movement of the lever member 70 relative to the adjustment portion 72 in the rotation axis Ax2 direction of the lever member 70 by contacting the adjustment portion 72 from at least one side in the rotation axis Ax2 direction of the lever member 70. In this manner, by bringing the adjustment portion 72 into contact with the first restriction portion 703, the movement of the lever member 70 relative to the adjustment portion 72 can be mechanically restricted.

In addition, the first restriction portion 703 has the through hole 704 through which the adjustment portion 72 passes. That is, by inserting the adjustment portion 72 into the through hole 704, the detachment of the lever member 70 and the bending fracture of the lever member 70 can be reliably prevented.

In addition, the maintaining structure includes the second restriction portion 705. The second restriction portion 705 projects from the contact piece (second contact piece 702) that contacts the tip face (contact-side end portion 721) of the adjustment portion 72 toward the base portion (the end portion on the side opposite to the contact-side end portion 721) side of the adjustment portion 72. Accordingly, the second restriction portion 705, together with the contact piece (second contact piece 702), surrounds the contact-side end portion 721 of the adjustment portion 72. Thus, in particular, the bending fracture of the lever member 70 can be reliably prevented.

Furthermore, the maintaining structure includes the reinforcing rib 706. The reinforcing rib 706 enhances the rigidity of the contact piece (first contact piece 701) that contacts the tip face (contact-side end portion 711) of the adjustment portion 71. Accordingly, in particular, the bending fracture of the contact piece (first contact piece 701) of the lever member 70 can be reliably prevented.

In addition, as described in the section of “[4.1] Tamper-resistant structure using caps”, in the present embodiment, the adjustment portion 71, 72 is tightened and fixed to the body 310, and the governor mechanism 7 further includes the sealing portion (the cap 74, 75, etc.). The sealing portion restricts a change in the amount of tightening of the adjustment portion 71, 72 relative to the body 310. Accordingly, it is also not easy to detach the adjustment portion 71, 72 from the body 310, and the resistance to illegal modification can be easily enhanced by maintaining the positional relationship between the lever member 70 and the adjustment portion 71, 72.

### [4.3] Tamper-Resistant Structure Using Cover Member

Next, the tamper-resistant structure using the cover member 8 will be described with reference to FIGS. 13 to 16.

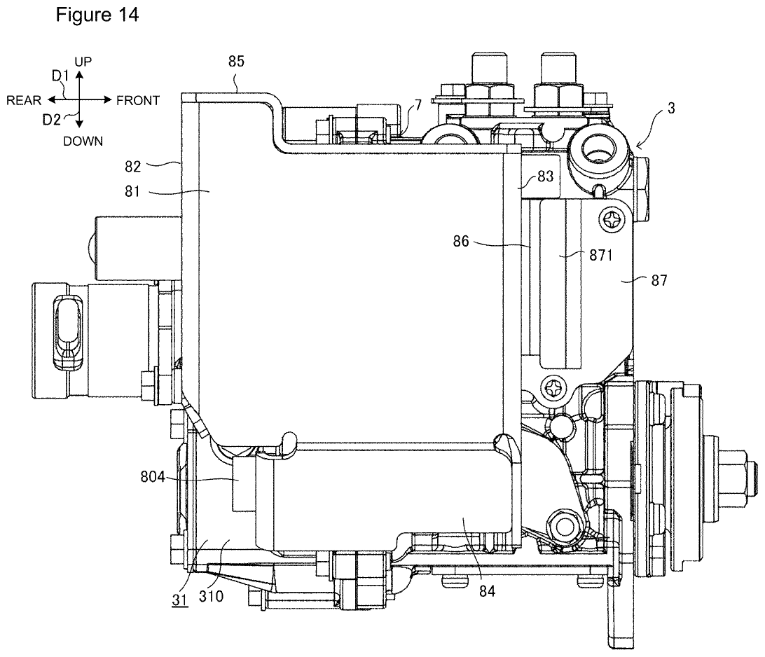

The cover member 8 covers at least one of the lever member 70 and the adjustment portion 71, 72, thereby making access to the lever member 70 and/or the adjustment portion 71, 72 difficult. Accordingly, the cover member 8 enhances resistance to illegal modification to the lever member 70 and/or the adjustment portion 71, 72. In the present embodiment, as shown in FIGS. 13 and 14, the cover member 8 is attached to the body 310 and covers all of the lever member 70 and the adjustment portions 71, 72 in a state in which the cover member 8 is attached to the body 310.

Specifically, the cover member 8 is made of a metal material such as an aluminum alloy or cast iron. The cover member 8 has desired durability (including rigidity, wear resistance, etc.). In the present embodiment, as an example, the cover member 8 is made of a metal plate having a predetermined thickness.

The cover member 8 includes a main plate 81, a rear wall plate 82, a front wall plate 83, a bottom plate 84, and a top plate 85. The main plate 81 has a thickness in the width direction D3 that is the rotation axis Ax2 (refer to FIG. 11) direction of the lever member 70. The rear wall plate 82 projects leftward from a rear end edge of the main plate 81. The front wall plate 83 projects leftward from a front end edge of the main plate 81. The bottom plate 84 projects leftward from a lower end edge of the main plate 81. The top plate 85 projects leftward from an upper end edge of the main plate 81. Accordingly, the cover member 8 is formed in a substantially box shape open leftward. The bottom plate 84 is inclined in such a manner as to extend obliquely downward and to the left from the lower end edge of the main plate 81.

The cover member 8 further includes a projection 86 projecting forward from a tip portion (left end portion) of the front wall plate 83, as shown in FIG. 14. A second cover 87 is fixed to the right side face of the body 310. A hook piece 871 that projects rightward and has a tip portion extending rearward is provided on a right side face of the second cover 87.

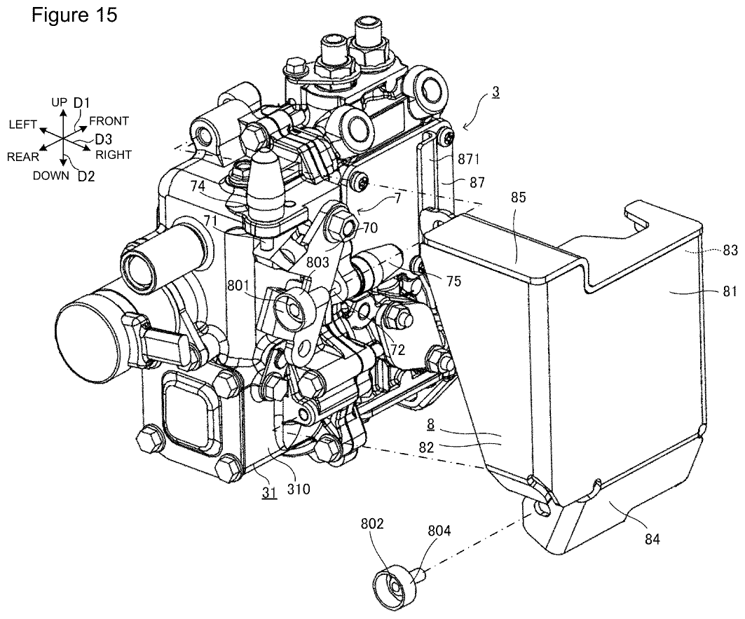

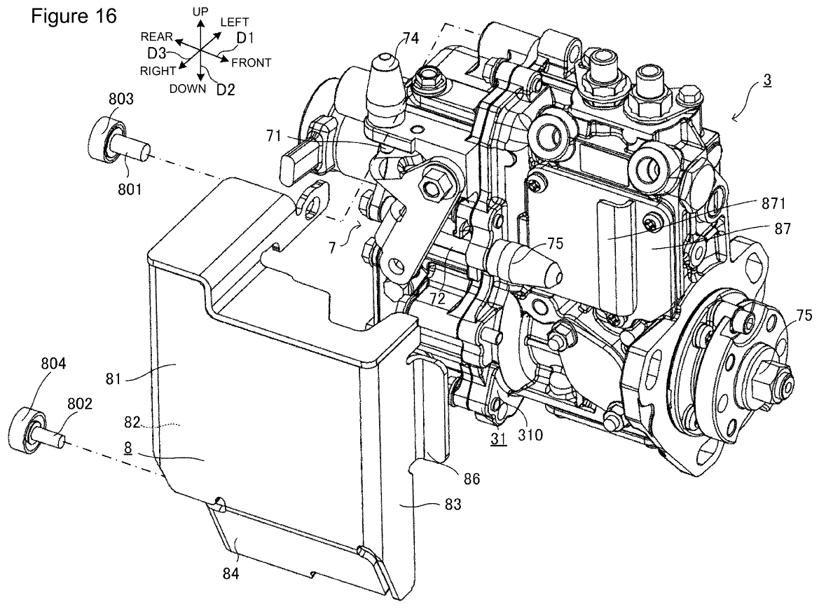

The cover member 8 is fixed to the body 310 using fixing portions 801, 802, with the projection 86 hooked on the hook piece 871, as shown in FIGS. 15 and 16. Here, the fixing portions 801, 802 are special bolts that are tightened using a special tool. In the present embodiment, the rear wall plate 82 of the cover member 8 is fixed to the body 310 using the fixing portions 801, 802.

Furthermore, cylindrical upright wall portions 803, 804 are fixed around the fixing portions 801, 802 in the cover member 8. The upright wall portions 803, 804 respectively surround the heads of the special bolts serving as the fixing portions 801, 802, thereby obstructing a tool from accessing the special bolts serving as the fixing portions 801, 802.

As described above, the fuel supply apparatus 3 according to the present embodiment includes the governor mechanism 7 that adjusts the output of the engine body 2. The governor mechanism 7 includes the lever member 70, the adjustment portion 71, 72, and the cover member 8. The lever member 70 is rotatably supported relative to the body 310. The adjustment portion 71, 72 adjusts the movable range of the lever member 70. The cover member 8 covers at least one of the lever member 70 and the adjustment portion 71, 72.

This makes it difficult for the end user to access the lever member 70 and/or the adjustment portion 71, 72 in the first place. That is, the end user cannot easily tighten or loosen the adjustment portion 71, 72 to or from the body 310, and cannot detach the adjustment portion 71, 72 from the body 310. Furthermore, the end user cannot easily detach the lever member 70 from the body 310, and cannot bend and break the lever member 70. Thus, the governor mechanism 7, by including the cover member 8 serving as the tamper-resistant structure, easily enhances resistance to illegal modification, particularly, to the lever member 70 and/or the adjustment portion 71, 72.

In addition, the cover member 8 covers at least the one end portion of the adjustment portion 71, 72 in the longitudinal direction. In the present embodiment, the cover member 8 covers the one end portion (tip portion 712) of the first adjustment portion 71 in the longitudinal direction with the top plate 85 and covers the one end portion (tip portion 722) of the second adjustment portion 72 in the longitudinal direction with the front wall plate 83. This enables the cover member 8 to easily enhance resistance to illegal modification, particularly, to the adjustment portion 71, 72.

Furthermore, the governor mechanism 7 includes the fixing portions 801, 802, and the upright wall portions 803, 804. The fixing portions 801, 802 fix the cover member 8 to the body 310. The upright wall portions 803, 804 surround the fixing portions 801, 802. Accordingly, the upright wall portions 803, 804 obstruct a tool from accessing the fixing portions 801, 802, thereby restraining the cover member 8 from being easily detached by the end user.

Here, the cover member 8 is fixed to the fuel injection pump 31 that pressure-feeds the fuel. Thus, the fuel supply apparatus 3 can be compactly configured, including the cover member 8.

In addition, the governor mechanism 7 further includes, in addition to a first cover as the cover member 8, the second cover 87 that covers a gap between the first cover (cover member 8) and the body 310. Accordingly, it is possible to restrain the cover member 8 from being broken and forcibly detached by prying the gap between the cover member 8 and the body 310.

The second cover 87 includes the hook piece 871. The first cover (cover member 8) includes the projection 86, and the movement of the projection 86 in the direction away from the body 310 is restricted by the projection 86 catching the hook piece 871. Accordingly, it is possible to restrain the cover member 8 from being broken and forcibly detached by prying the gap between the cover member 8 and the body 310.

### [4.4] Other Tamper-Resistant Structures

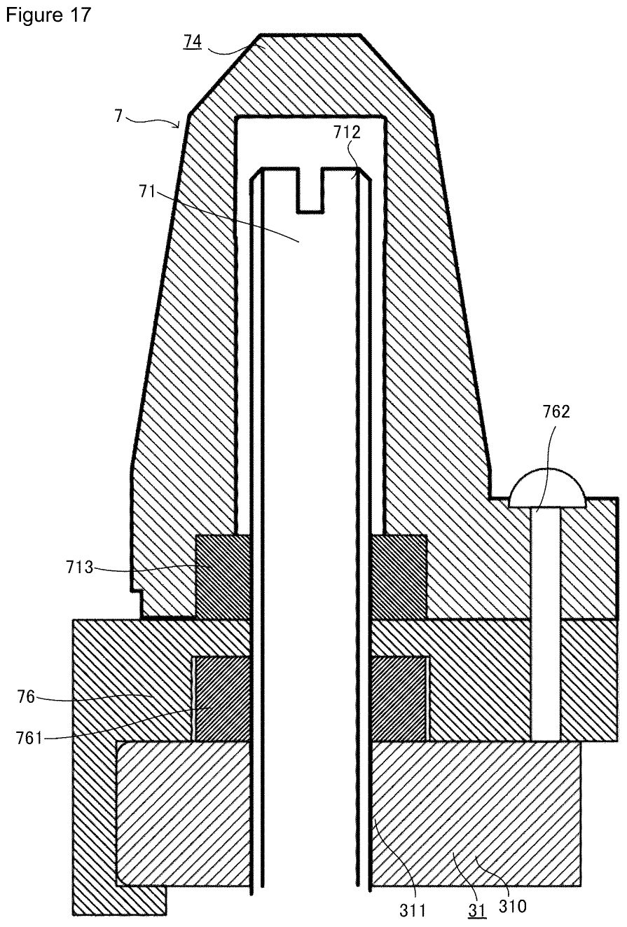

Tamper-resistant structures other than those described above will be described with reference to FIGS. 17 to 19.

In FIG. 17, the sealing portion further includes a rotation stopping portion 76 that restricts rotation of the cap 74 about the adjustment portion 71. In the example of FIG. 17, the rotation stopping portion 76 is interposed between the cap 74 and the first retaining piece 311. The rotation stopping portion 76, for example, holds an edge portion of the first retaining piece 311, and rotation relative to the first retaining piece 311 is prohibited. The rotation stopping portion 76 is fixed to the first retaining piece 311 with a nut 761. The cap 74 is fastened to the rotation stopping portion 76 with a fastener 762. The fastener 762 is preferably a fastener that cannot be detached by the end user, such as a shear bolt.

With this configuration, since the rotation stopping portion 76 restricts the rotation of the cap 74, it is possible to restrain the breakage of the cap 74 caused by the cap 74 being rotated together with the fixing nut 713.

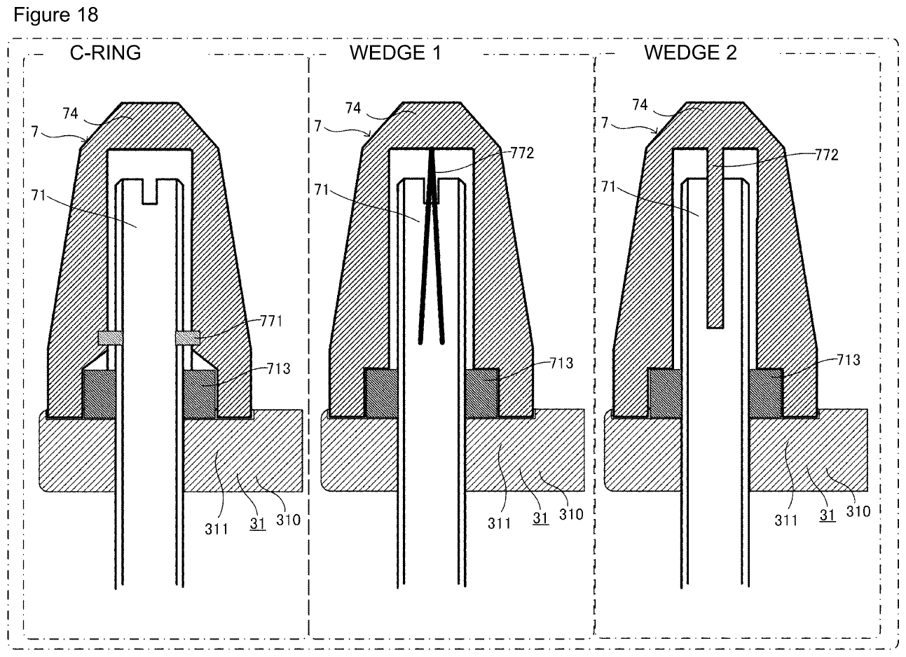

In FIG. 18, means other than the elastic member 714 is used for joining the cap 74 and the adjustment portion 71. In addition, in the example of FIG. 18, a counterbore portion is formed at a contact part of the first retaining piece 311 with the cap 74, thereby preventing a gap into which a tool or the like is insertable being left between the first retaining piece 311 and the cap 74.

For example, in a case of a “C-ring”, the joining between the cap 74 and the adjustment portion 71 is performed by a C-ring 771 attached to the adjustment portion 71. In a case of a “wedge 1”, the joining between the cap 74 and the adjustment portion 71 is performed by inserting a wedge structure 772 projecting from an inner bottom face of the cap 74 into a hole of the adjustment portion 71. In a case of a “wedge 2”, the joining between the cap 74 and the adjustment portion 71 is performed by inserting a wedge structure 773 projecting from the inner bottom face of the cap 74 into the hole of the adjustment portion 71. In any of the configurations illustrated in FIG. 18, the cap 74 can be attached by striking the cap 74 onto the adjustment portion 71 from above so as to cover the adjustment portion 71.

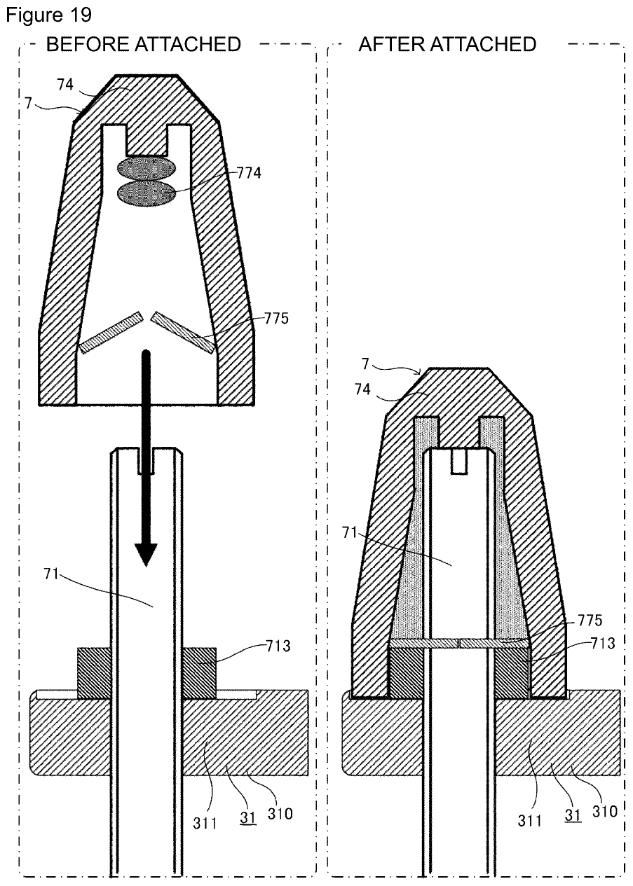

In FIG. 19, still another means is used for joining the cap 74 and the adjustment portion 71. In the example of FIG. 19, the joining between the cap 74 and the adjustment portion 71 is performed by pushing doors 775 in a closing direction using liquid bags 774 of two-component urethane or the like incorporated on the inner bottom face of the cap 74. That is, by the liquid bags 774 being crushed by the adjustment portion 71, the two-component urethane inside the liquid bags 774 is charged into the cap 74. By pushing the doors 775 in the closing direction, the joining between the cap 74 and the adjustment portion 71 is performed with the adjustment portion 71 held between the doors 775. In this case, the cap 74 is preferably formed with an escape hole for the two-component urethane.

### [5] Modifications

Hereinbelow, modifications of the first embodiment will be listed. The modifications described below are applicable in any appropriate combinations.

The engine system 1 in the present disclosure includes a computer system as the control unit 11. The computer system includes, as a principal configuration, one or more processors and one or more memories as hardware. The functions of the control unit 11 in the present disclosure are implemented by the processor executing a program recorded in the memory of the computer system. The program may be previously recorded in the memory of the computer system, may be provided through a telecommunication line, or may be provided by being recorded on a non-transitory recording medium readable by the computer system, such as a memory card, an optical disk, or a hard disk drive. In addition, some or all of the functional units included in the control unit 11 may be configured as electronic circuits.

In addition, at least some of the functions of the engine system 1 being collected within a single housing is not an essential configuration for the engine system 1, and the components of the engine system 1 may be distributed to a plurality of housings. For example, the control unit 11 may be separated into a control unit for the engine body 2 and a control unit for the fuel supply apparatus 3. On the contrary, the functions distributed to a plurality of devices in the first embodiment may be collected within a single housing.

The engine body 2 is not limited to a diesel engine using light oil as fuel, and may be, for example, a gasoline engine using gasoline as fuel or a hydrogen fuel engine (hydrogen fueled internal combustion engine) using hydrogen as fuel. Furthermore, the engine system 1 may be a so-called dual-fuel engine (DF engine) adaptable to both a premixed combustion system in which gaseous fuel is mixed with air and then introduced into the combustion chamber and a diffusion combustion system in which liquid fuel is injected into the combustion chamber for combustion. Here, the gaseous fuel is, for example, hydrogen, and the liquid fuel is, for example, a fossil fuel (such as light oil or gasoline). More specifically, by using light oil as the liquid fuel, the engine system 1 is adaptable to both a gas mode using hydrogen as fuel and a diesel mode using light oil as fuel. Here, in the gas mode, a small amount of liquid fuel (such as light oil) may additionally be used as an ignition fuel.

Furthermore, at least a part of the engine system 1 is not limited to being mounted on the object body of the mobile object and may be provided separately from the object body of the mobile object. As an example, when the control unit 11 is embodied by a server device provided separately from the object body of the mobile object, communication between the server device and (a communication device of) the mobile object enables the control unit 11 to control the engine system 1. At least some of the functions of the control unit 11 may be implemented by cloud (cloud computing) or the like.

In addition, the mobile object on which the engine system 1 is mounted is not limited to a tractor, and the engine system 1 may be used in a mobile object such as another work vehicle, a marine vessel, or a flying body. The engine system 1 may be used in an object other than mobile objects.

In addition, the engine system 1 is not limited to an in-line multi-cylinder engine in which a plurality of cylinders are arranged in series, and may be, for example, a V-type engine in which a plurality of cylinders are arranged in a V-shape with the rotation axis Ax1 of the crankshaft 23 serving as the vertex or a horizontally opposed cylinder engine.

In addition, the engine system 1 may be a single-cylinder engine including only one cylinder.

### Second Embodiment

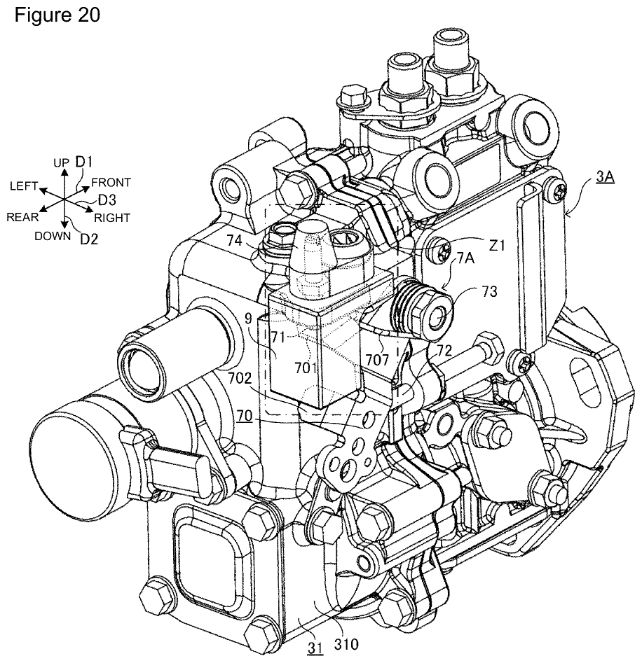

A fuel supply apparatus 3A according to the present embodiment differs from the fuel supply apparatus 3 according to the first embodiment mainly in that a governor mechanism 7A includes a guard member 9 instead of the cover member 8, as shown in FIG. 20. Hereinbelow, configurations similar to those of the first embodiment are designated by the same reference signs to omit description as appropriate.

In addition, in the present embodiment, the detailed configurations of the lever member 70 and the like also differ from those of the first embodiment. For example, in the lever member 70 in the present embodiment, the first restriction portion 703, the second restriction portion 705, the reinforcing rib 706, and the like are eliminated, and the lever member 70 includes a plurality of lightening holes. Furthermore, the governor mechanism 7A includes a return spring 707 (refer to FIG. 20) that biases the lever member 70 in the counterclockwise direction A2 (refer to FIG. 6) about the shaft 73.

The guard member 9 is an example of the cover member that covers at least one of the lever member 70 and the adjustment portion 71, 72, and is a member that covers a contact part of the first adjustment portion 71 with the lever member 70. That is, the contact-side end portion 711 that is the end portion (lower end portion) of the first adjustment portion 71 on the lever member 70 side in the longitudinal direction (up-down direction D2) abuts against the first contact piece 701 of the lever member 70 from above, and the guard member 9 covers at least the contact-side end portion 711.

More specifically, the first adjustment portion 71 is fixed to the body 310 in such a manner as to penetrate the first retaining piece 311 of the body 310 in the thickness direction (up-down direction D2). Thus, the end portion (lower end portion) of the first adjustment portion 71 located on the lever member 70 side as viewed from the first retaining piece 311 is covered, as the contact-side end portion 711, with the guard member 9.

The guard member 9 makes access to the contact part between the first adjustment portion 71 and the lever member 70 difficult by covering the contact part (contact-side end portion 711) of the first adjustment portion 71 with the lever member 70 from at least one side. Accordingly, the guard member 9 enhances resistance to illegal modification to the lever member 70 and/or the first adjustment portion 71.

In the present embodiment, as shown in FIGS. 20 to 22, the guard member 9 is attached to the body 310 and, in the state attached to the body 310, covers the contact part (contact-side end portion 711) of the first adjustment portion 71 with the lever member 70. Here, as an example, the guard member 9 is located rightward and rearward of the contact-side end portion 711 of the first adjustment portion 71, and covers the contact-side end portion 711 from two directions, specifically, the right side and the rear side.

Specifically, the guard member 9 is made of, for example, a metal material such as an aluminum alloy or cast iron, and has desired durability (including rigidity, wear resistance, etc.). In the present embodiment, as an example, the guard member 9 is made of a metal plate having a predetermined thickness.

Here, the guard member 9 is fixed in such a manner as to be sandwiched between the cap 74 and the first retaining piece 311. The cap 74 is attached to a part of the first adjustment portion 71 on the side opposite to the lever member 70 as viewed from the first retaining piece 311. The cap 74 has a bottomed tubular shape. In a state in which the cap 74 is attached to the first adjustment portion 71, the cap 74 covers, together with the fixing nut 713, the part of the first adjustment portion 71 on the side opposite to the lever member 70 as viewed from the first retaining piece 311.

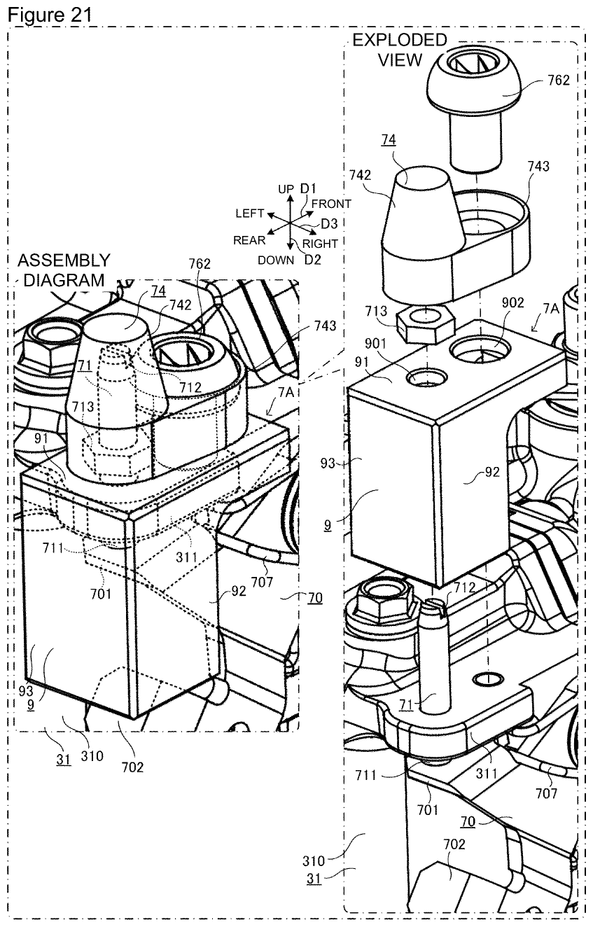

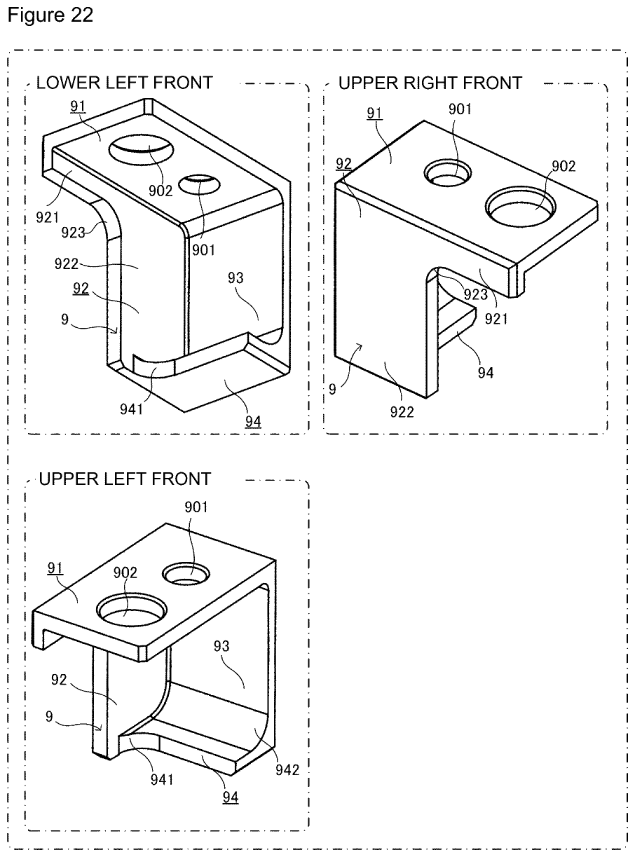

In the present embodiment, as shown in FIGS. 21 and 22, the guard member 9 includes a horizontal plate 91, a right plate 92, a rear plate 93, and a lower plate 94. The horizontal plate 91 has a thickness in the longitudinal direction of the first adjustment portion 71 (up-down direction D2). The right plate 92 projects downward from a right end edge of the horizontal plate 91. The rear plate 93 projects downward from a rear end edge of the horizontal plate 91. The lower plate 94 projects forward from a lower end edge of the rear plate 93. Accordingly, the guard member 9 is formed in a substantially box shape open at least leftward and forward.

Relative to the rear plate 93, a forward projecting amount from the rear plate 93 is largest for the horizontal plate 91, followed by the right plate 92 and then the lower plate 94 in descending order. That is, the forward projecting amount of the lower plate 94 from the rear plate 93 is smaller than that of the horizontal plate 91 and the right plate 92. This avoids interference between the guard member 9 and the lever member 70 or the like.

The horizontal plate 91 of the guard member 9 is formed with a first through hole 901 and a second through hole 902 that penetrate the horizontal plate 91 in the thickness direction (up-down direction D2). The first through hole 901 is slightly larger than the outer diameter of the first adjustment portion 71, and the second through hole 902 is slightly larger than the outer diameter of a fastener 762. The fastener 762 is a fastener such as a bolt for fixing the cap 74 to the first retaining piece 311 of the body 310.

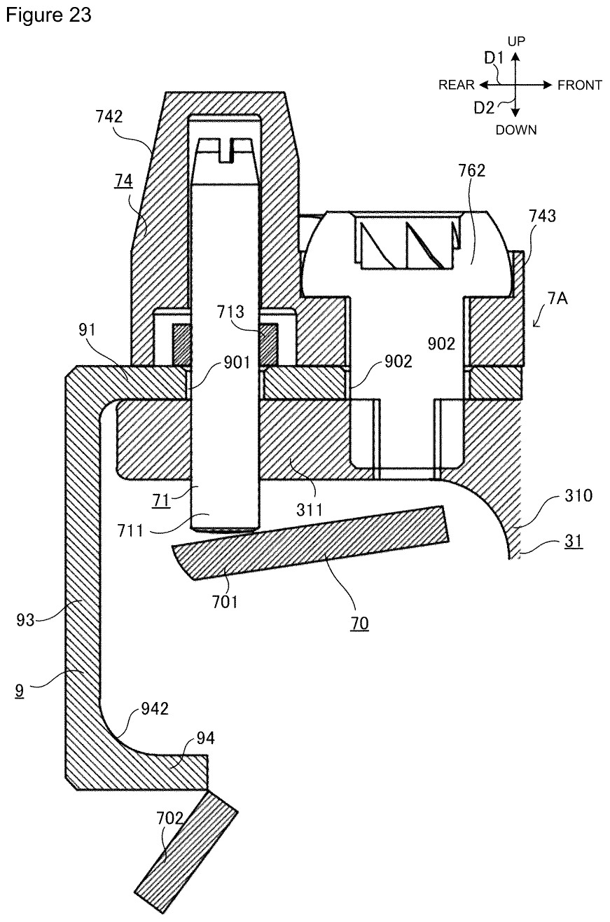

As shown in FIG. 23, the first adjustment portion 71 is tightened and fixed to the first retaining piece 311 below the horizontal plate 91 in a state in which the first adjustment portion 71 penetrates the horizontal plate 91 through the first through hole 901. Furthermore, the fixing nut 713 is tightened to the first adjustment portion 71 from above the horizontal plate 91.

In addition, as shown in FIG. 23, the fastener 762 is tightened and fixed to the first retaining piece 311 below the horizontal plate 91 in a state in which the fastener 762 penetrates the horizontal plate 91 through the second through hole 902. That is, the fastener 762 fastens (the horizontal plate 91 of) the guard member 9 together with the cap 74 to the first retaining piece 311. Accordingly, the guard member 9 is fixed to the first retaining piece 311 with the horizontal plate 91 sandwiched between the cap 74 and first retaining piece 311.

Here, the fastener 762 is, for example, a special bolt that cannot be detached by the end user, such as a one-way bolt that only allows tightening operation. Thus, in a state in which the fastener 762 is tightened and the horizontal plate 91 is sandwiched between the cap 74 and the first retaining piece 311, not only the cap 74 but also the guard member 9 is prohibited from being detached from the body 310 (first retaining piece 311).

Furthermore, a cylindrical peripheral wall portion 743 is formed on the cap 74 around the head of the fastener 762. The peripheral wall portion 743 surrounds the head of the special bolt serving as the fastener 762, thereby obstructing a tool from accessing the special bolt serving as the fastener 762 and also prohibits the fastener 762 from being detached by forcibly gripping its head.

In addition, as shown in FIG. 22, the right plate 92 includes a first piece 921 formed throughout the entire length of the horizontal plate 91 in the longitudinal direction (output shaft direction D1), and a second piece 922 projecting downward from a rear part of the first piece 921. An R-processed first reinforcing portion 923 is formed on an inside corner between the first piece 921 and the second piece 922. By setting the curvature radius of the first reinforcing portion 923 relatively large, it is possible to restrain fracture of the guard member 9 caused by stress concentration while avoiding interference with the return spring 707.

In addition, as shown in FIG. 22, an R-processed second reinforcing portion 941 is formed on an inside corner between the right plate 92 and the lower plate 94. Similarly, an R-processed third reinforcing portion 942 is formed on an inside corner between the rear plate 93 and the lower plate 94. Providing the second reinforcing portion 941 and the third reinforcing portion 942 makes it possible to restrain fracture of the guard member 9 caused by stress concentration.

As described above, in the fuel supply apparatus 3A according to the present embodiment, the governor mechanism 7A that adjusts the output of the engine body 2 includes the guard member 9 as the cover member. The guard member 9 covers the contact part (contact-side end portion 711) of the (first) adjustment portion 71 with the lever member 70.

This makes it difficult for the end user to access the contact part of the (first) adjustment portion 71 with the lever member 70. That is, the end user cannot easily tighten or loosen the (first) adjustment portion 71 to or from the body 310, and cannot detach the (first) adjustment portion 71 from the body 310. Thus, the governor mechanism 7A, by including the guard member 9 as the tamper-resistant structure, can easily enhance resistance to illegal modification, particularly, to the contact part (contact-side end portion 711) of the (first) adjustment portion 71 with the lever member 70.

In addition, the guard member 9 covers the contact part of the (first) adjustment portion 71 with the lever member 70 from at least one side in a direction (the output shaft direction D1 or the width direction D3) perpendicular to the longitudinal direction of the (first) adjustment portion 71 (up-down direction D2). In the present embodiment, as an example, the guard member 9 covers the contact-side end portion 711 from two directions, specifically, the right side and the rear side, using the right plate 92 and the rear plate 93. This enables the guard member 9 to easily enhance resistance particularly to illegal modification involving grasping and illegally operating the (first) adjustment portion 71.

In addition, the guard member 9 covers the contact part of the (first) adjustment portion 71 with the lever member 70 from at least one side in the longitudinal direction of the (first) adjustment portion 71 (up-down direction D2). In the present embodiment, as an example, the guard member 9 covers the contact-side end portion 711 from two directions, specifically, the upper side and the lower side, using the horizontal plate 91 and the lower plate 94. This enables the guard member 9 to easily enhance resistance particularly to illegal modification involving grasping and illegally operating the (first) adjustment portion 71.

In addition, the guard member 9 is fixed to the body 310 in such a manner as to be sandwiched between the cap 74 and (the first retaining piece 311 of) the body 310. The cap 74 covers the end portion (tip portion 712) of the (first) adjustment portion 71 on the side opposite to the lever member 70 in the longitudinal direction. This makes the guard member 9 undetachable from the body 310 without destruction unless the cap 74 is detached, and restrains the guard member 9 from being easily detached by the end user.

As a modification of the second embodiment, the guard member 9 may be adopted together with the cover member 8 described in the first embodiment. This enables the adjustment portion 71 to be doubly covered with the guard member 9 and the cover member 8 and more easily enhances resistance to illegal modification.

The configurations of the second embodiment (including the modification) can be adopted in combination with the various configurations (including the modifications) described in the first embodiment as appropriate.

### Third Embodiment

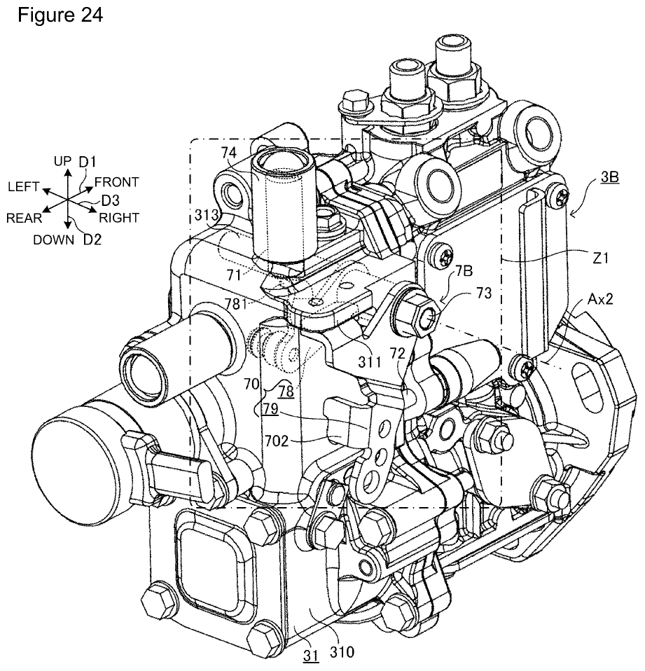

A fuel supply apparatus 3B according to the present embodiment differs from the fuel supply apparatus 3 according to the first embodiment mainly in that, as shown in FIG. 24, a governor mechanism 7B is configured to bring the first adjustment portion 71 into contact with an inner contact piece 781 of the lever member 70. Hereinbelow, configurations similar to those of the first embodiment are designated by the same reference signs to omit description as appropriate.

In addition, in the present embodiment, the detailed configurations of the lever member 70 and the like also differ from those of the first embodiment. For example, in the lever member 70 in the present embodiment, the first restriction portion 703, the second restriction portion 705, the reinforcing rib 706, and the like are eliminated, and the lever member 70 includes a plurality of lightening holes. Furthermore, the shape of the cap 74 attached to the first adjustment portion 71 differs from that in the first embodiment. In the present embodiment, the cap 74 is formed in a cylindrical shape without the tapered surface 742.

In the present embodiment, the inner contact piece 781 is disposed inside the body 310. The first adjustment portion 71 is tightened and fixed to the body 310 in such a manner as to penetrate an upper wall 313 of the body 310. Accordingly, one end portion (contact-side end portion 711) of the first adjustment portion 71 in the longitudinal direction (up-down direction D2) is located in an internal space of the body 310, and the other end portion (tip portion 712) in the longitudinal direction (up-down direction D2) is located in an external space of (above) the body 310.

Here, the contact-side end portion 711 of the first adjustment portion 71 is fixed to the body 310 above the inner contact piece 781 inside (in the internal space of) the body 310 in a state in which the contact-side end portion 711 abuts against the inner contact piece 781 from above. The first adjustment portion 71 restricts the rotation of the lever member 70 in the clockwise direction A1 by bringing the contact-side end portion 711 that is the end portion (lower end portion) on the lever member 70 (inner contact piece 781) side in the longitudinal direction (up-down direction D2) into contact with the inner contact piece 781 of the lever member 70. That is, the first adjustment portion 71 defines the upper limit of the fuel supply amount by limiting the movable range of the lever member 70 in the clockwise direction A1, and in turn defines the upper limit of the output (mainly, the rotation speed) of the engine body 2.

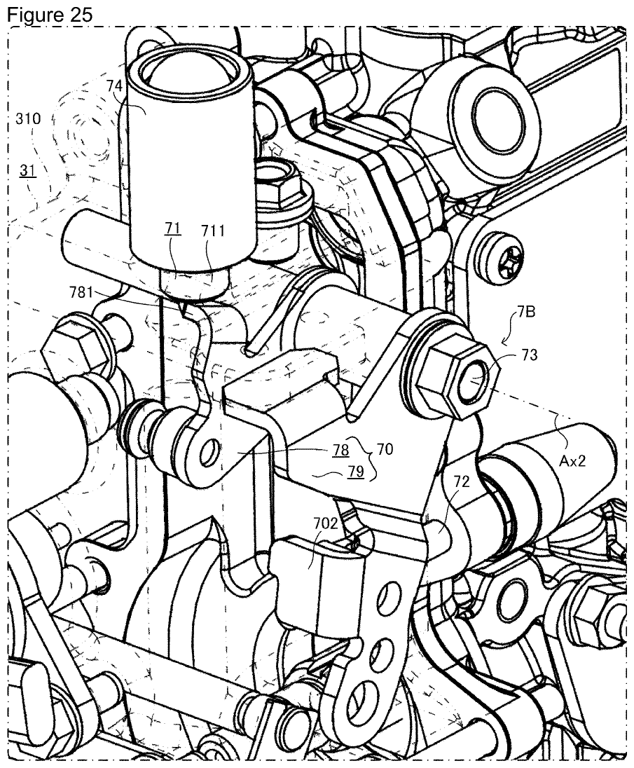

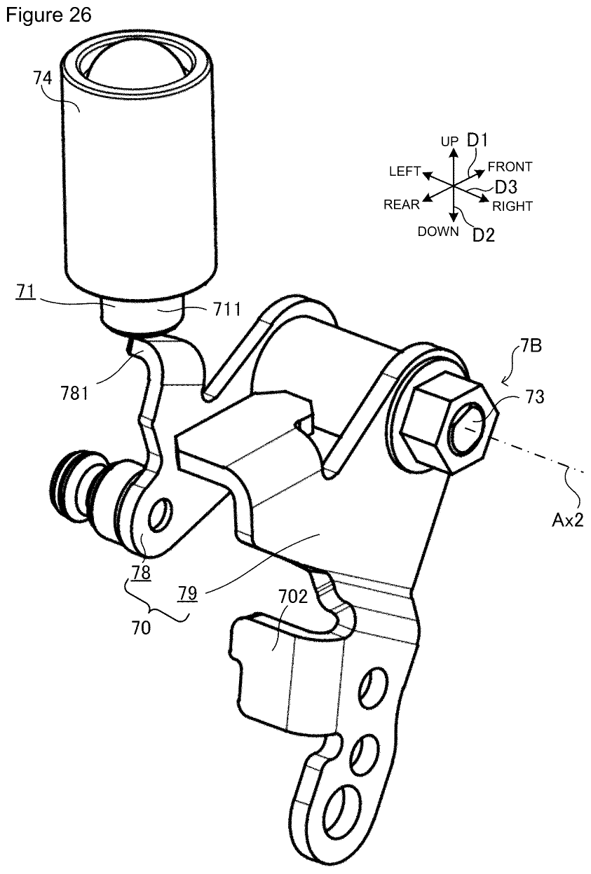

More specifically, in the governor mechanism 7B, as shown in FIGS. 25 and 26, the lever member 70 includes an inner lever 78, and an outer lever 79. In FIG. 25, the body 310 is indicated by imaginary lines (long dashed double-short dashed lines). The inner lever 78 is disposed in the internal space of the body 310, that is, the space enclosed by the body 310. On the other hand, the outer lever 79 is disposed outside the body 310 (on the right side in the present embodiment).

The inner lever 78 and the outer lever 79 are coupled through the shaft 73. Accordingly, both the inner lever 78 and the outer lever 79 are supported on the body 310 in a state in which the inner lever 78 and the outer lever 79 are rotatable about the rotation axis Ax2 that is the axis of the shaft 73. Thus, the lever member 70 is configured in such a manner that the inner lever 78 and the outer lever 79 are integrally rotatable about the rotation axis Ax2.

In the present embodiment, the inner lever 78 is an operation element (control lever) that increases and reduces the fuel supply amount in the fuel injection pump 31. That is, by the lever member 70 rotating relative to the body 310, the fuel supply amount in the fuel injection pump 31 is increased or reduced in accordance with a rotation angle of the inner lever 78.

The inner lever 78 includes the inner contact piece 781. That is, the inner lever 78 made of a metal plate has a part that is bent to constitute the inner contact piece 781. In the present embodiment, the shaft 73 is located at an intermediate portion of the inner lever 78 in the longitudinal direction, and the inner contact piece 781 is located at one end portion of the inner lever 78 in the longitudinal direction. That is, the inner contact piece 781 is located at a position away from the rotation axis Ax2 in the longitudinal direction of the inner lever 78.

On the other hand, in the present embodiment, the second contact piece 702 that abuts against the second adjustment portion 72 is provided on the outer lever 79, as with the first embodiment. That is, in the lever member 70, the inner lever 78 includes the inner contact piece 781 that is brought into contact with the first adjustment portion 71 so that the inner contact piece 781 is located inside the body 310. On the other hand, the outer lever 79 includes the second contact piece 702 that is brought into contact with the second adjustment portion 72 so that the second contact piece 702 is located outside the body 310.

In the present embodiment, the inner contact piece 781 projects toward the side (leftward) opposite to the outer lever 79 in the width direction D3 from a side edge portion of the inner lever 78 pointing in the clockwise direction A1 (refer to FIG. 6). The movable range of the lever member 70 in the clockwise direction A1 is limited by bringing the inner contact piece 781 of the inner lever 78 into contact with the contact-side end portion 711 of the first adjustment portion 71 from below. On the other hand, the movable range of the lever member 70 in the counterclockwise direction A2 (refer to FIG. 6) is limited by bringing the second contact piece 702 of the outer lever 79 into contact with the contact-side end portion 721 of the second adjustment portion 72 from the rear side.

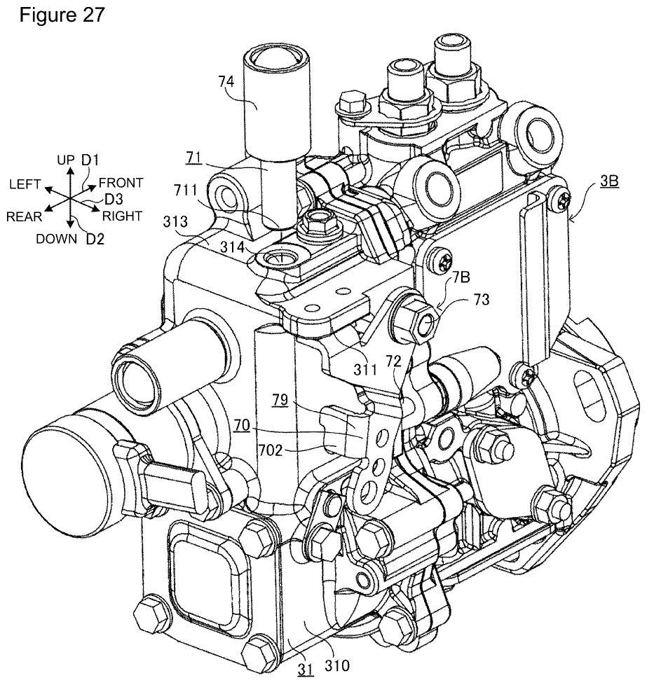

The first adjustment portion 71 is tightened and fixed to the upper wall 313 of the body 310, as shown in FIG. 27. The upper wall 313 is a plate-shaped portion having a thickness in the up-down direction D2 and constitutes the upper face of the body 310. The upper wall 313 has a through hole 314 that penetrates the upper wall 313 in the thickness direction (up-down direction D2). The through hole 314 has threads (female threads) formed on its inner peripheral face and constitutes a threaded hole into which the first adjustment portion 71 is tightened. That is, the first adjustment portion 71 is fixed to the body 310 in such a manner as to penetrate the upper wall 313 in the thickness direction (up-down direction D2).

In the first adjustment portion 71, an end portion (lower end portion) located on the lever member 70 side as viewed from the upper wall 313 in the longitudinal direction (up-down direction D2) is defined as the contact-side end portion 711, and the contact-side end portion 711 faces the inner contact piece 781 of the lever member 70. With this configuration, the (downward) projecting amount of the contact-side end portion 711 as viewed from the upper wall 313 changes in accordance with the amount of tightening of the first adjustment portion 71 relative to the upper wall 313.

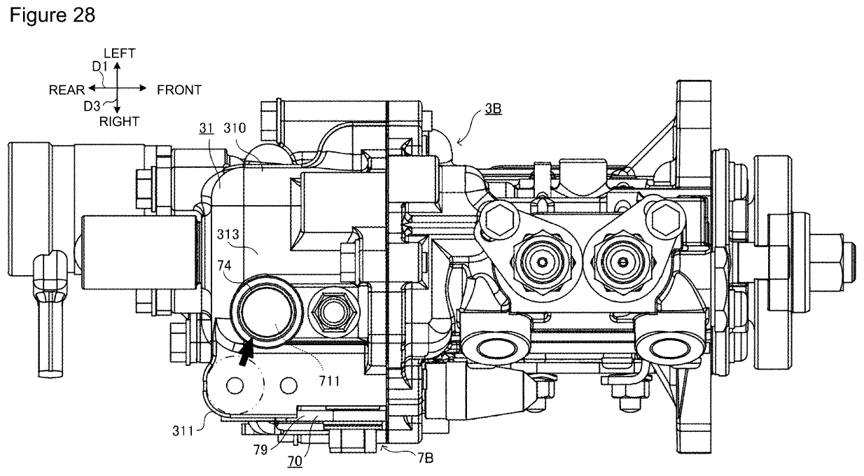

In the present embodiment, as described above, the first adjustment portion 71 is fixed to the body 310 in such a manner as to penetrate the upper wall 313 of the body 310. Thus, as shown in FIG. 28, the first adjustment portion 71 shifts to a position closer to the center of the body 310 in the width direction D3, compared to a case in which the first adjustment portion 71 is retained by the first retaining piece 311 (indicated by an imaginary line (long dashed double-short dashed line)).

As described above, in the fuel supply apparatus 3B according to the present embodiment, the lever member 70 includes the inner contact piece 781 inside the body 310. The (first) adjustment portion 71 limits the movable range of the lever member 70 by contacting the inner contact piece 781.

This makes it difficult for the end user to access the contact part of the (first) adjustment portion 71 with the lever member 70. That is, the end user cannot easily tighten or loosen the (first) adjustment portion 71 to or from the body 310, and cannot detach the (first) adjustment portion 71 from the body 310. Thus, the governor mechanism 7B, by including the inner contact piece 781, can easily enhance resistance to illegal modification, particularly, to the contact part of the (first) adjustment portion 71 with the lever member 70.

In addition, the inner contact piece 781 is disposed on the inner lever 78 of the lever member 70. The inner lever 78 is the operation element (control lever) that increases and reduces the fuel supply amount in the fuel injection pump. This enables the inner contact piece 781 to be provided by using the inner lever 78 as the operation element (control lever).

In the third embodiment, the first contact piece that limits the movable range of the lever member 70 in the clockwise direction A1 by contacting the first adjustment portion 71 is implemented by the inner contact piece 781 disposed inside the body 310, but this is not a limitation. That is, at least one of the first contact piece and the second contact piece may be implemented by the inner contact piece disposed inside the body 310. For example, the second contact piece that limits the movable range of the lever member 70 in the counterclockwise direction A2 by contacting the second adjustment portion 72 may be implemented by the inner contact piece disposed inside the body 310.

In addition, a configuration in which the movable range of the lever member 70 can also be limited by the first contact piece 701 of the outer lever 79 in addition to the inner contact piece 781 by also fixing the (first) adjustment portion 71 to the first retaining piece 311 may be adopted.

The configurations of the third embodiment (including the modifications) can be adopted in combination with the various configurations (including the modifications) described in the first embodiment or the second embodiment as appropriate.

### CLAUSES

The followings are Clauses regarding the summary of the invention extracted from the above-mentioned embodiments. Note that the configurations and processing functions described in the following Clauses can be selected and combined as appropriate.

### Clause 1

A fuel supply apparatus that supplies fuel to an engine body, the fuel supply apparatus including
a governor mechanism that adjusts a supply amount of the fuel to the engine body, in which
the governor mechanism includes
   an adjustment portion that is tightened and fixed to a body and adjusts at least one of an upper limit and a lower limit of the supply amount of the fuel to the engine body in accordance with an amount of tightening relative to the body, and
   a sealing portion that restricts a change in the amount of tightening of the adjustment portion.

### Clause 2

The fuel supply apparatus according to Clause 1, in which
the sealing portion includes a cap having a bottomed tubular shape, the cap attached to the adjustment portion in a manner in which one end portion of the adjustment portion in a longitudinal direction is inserted in the cap, the cap undetachable from the adjustment portion without destruction.

### Clause 3

The fuel supply apparatus according to Clause 2, in which
the sealing portion further includes a collar located inside the cap, and the one end portion of the adjustment portion in the longitudinal direction penetrates the collar.

### Clause 4

The fuel supply apparatus according to Clause 3, in which
a nut provided at the one end portion of the adjustment portion in the longitudinal direction has a flange that restricts movement of the collar in a direction of coming off the adjustment portion.

### Clause 5

The fuel supply apparatus according to any one of Clauses 2 to 4, in which
the cap has a tapered surface having an outer diameter that decreases toward a tip side.

### Clause 6

The fuel supply apparatus according to any one of Clauses 2 to 5, in which
the sealing portion further includes a washer that fills a gap between an opening peripheral edge of the cap and the adjustment portion.

### Clause 7

The fuel supply apparatus according to any one of Clauses 2 to 6, in which
the sealing portion includes an elastic member located inside the cap, the elastic member attached to the one end portion of the adjustment portion in the longitudinal direction to prevent the cap from coming off the adjustment portion.

### Clause 8

The fuel supply apparatus according to any one of Clauses 2 to 7, in which
the sealing portion further includes a rotation stopping portion that restricts rotation of the cap about the adjustment portion.

### Clause 9

An engine system including:
the fuel supply apparatus according to any one of Clauses 1 to 8; and
the engine body.

### Clause 10

A fuel supply apparatus that supplies fuel to an engine body, the fuel supply apparatus including
a governor mechanism that adjusts a supply amount of the fuel to the engine body, in which
the governor mechanism includes
   a lever member rotatably supported relative to a body, and
   an adjustment portion that adjusts a movable range of the lever member, and
the lever member includes a maintaining structure that maintains a positional relationship with the adjustment portion.

### Clause 11

The fuel supply apparatus according to Clause 10, in which
the maintaining structure includes a first restriction portion that restricts movement of the lever member relative to the adjustment portion in a rotation axis direction of the lever member.

### Clause 12

The fuel supply apparatus according to Clause 11, in which
the first restriction portion restricts movement of the lever member relative to the adjustment portion in the rotation axis direction of the lever member by contacting the adjustment portion from at least one side in the rotation axis direction of the lever member.

### Clause 13

The fuel supply apparatus according to Clause 11 or 12, in which
the first restriction portion has a through hole through which the adjustment portion passes.

### Clause 14

The fuel supply apparatus according to any one of Clauses 10 to 13, in which
the maintaining structure includes a second restriction portion projecting toward a base portion side of the adjustment portion from a contact piece that contacts a tip face of the adjustment portion.

### Clause 15

The fuel supply apparatus according to any one of Clauses 10 to 14, in which
the maintaining structure includes a reinforcing rib that enhances rigidity of a contact piece that contacts a tip face of the adjustment portion.

### Clause 16

The fuel supply apparatus according to any one of Clauses 10 to 15, in which
the adjustment portion is tightened and fixed to the body, and
the governor mechanism further includes a sealing portion that restricts a change in the amount of tightening of the adjustment portion relative to the body.

### Clause 17

The fuel supply apparatus according to Clause 16, in which
the lever member includes an inner contact piece inside the body, and
the adjustment portion limits the movable range of the lever member by contacting the inner contact piece.

### Clause 18

The fuel supply apparatus according to Clause 17, in which
the inner contact piece is disposed on an inner lever of the lever member, and
the inner lever is an operation element that increases and reduces a supply amount of the fuel in a fuel injection pump.

### Clause 19

An engine system including:
the fuel supply apparatus according to any one of Clauses 10 to 17; and
the engine body.

### Clause 20

A fuel supply apparatus that supplies fuel to an engine body, the fuel supply apparatus including
a governor mechanism that adjusts a supply amount of the fuel to the engine body, in which
the governor mechanism includes
   a lever member rotatably supported relative to a body, and
   an adjustment portion that adjusts a movable range of the lever member, and
a cover member that covers at least one of the lever member and the adjustment portion.

### Clause 21

The fuel supply apparatus according to Clause 20, in which
the cover member covers at least one end portion of the adjustment portion in a longitudinal direction.

### Clause 22

The fuel supply apparatus according to Clause 20 or 21, in which
the governor mechanism further includes
   a fixing portion that fixes the cover member to the body, and
   an upright wall portion surrounding the fixing portion.

### Clause 23

The fuel supply apparatus according to any one of Clauses 20 to 22, in which
the cover member is fixed to a fuel injection pump that pressure-feeds the fuel.

### Clause 24

The fuel supply apparatus according to any one of Clauses 20 to 23, in which
the governor mechanism further includes, in addition to a first cover serving as the cover member, a second cover that covers a gap between the first cover and the body.

### Clause 25

The fuel supply apparatus according to Clause 24, in which
the second cover includes a hook piece, and
the first cover includes a projection, and movement of the projection in a direction away from the body is restricted by the projection catching the hook piece.

### Clause 26

The fuel supply apparatus according to any one of Clauses 20 to 25, in which
the governor mechanism includes a guard member as the cover member, and
the guard member covers a contact part of the adjustment portion with the lever member.

### Clause 27

The fuel supply apparatus according to Clause 26, in which
the guard member covers the contact part of the adjustment portion with the lever member from at least one side in a direction perpendicular to the longitudinal direction of the adjustment portion.

### Clause 28

The fuel supply apparatus according to Clause 26 or 27, in which
the guard member covers the contact part of the adjustment portion with the lever member from at least one side in the longitudinal direction of the adjustment portion.

### Clause 29

The fuel supply apparatus according to any one of Clauses 26 to 28, in which
the guard member is fixed to the body in such a manner as to be sandwiched between a cap and the body, and
the cap covers an end portion of the adjustment portion on a side opposite to the lever member in the longitudinal direction.

### Clause 30

An engine system including:
the fuel supply apparatus according to any one of Clauses 20 to 29; and
the engine body.

### REFERENCE SIGNS LIST

1 engine system
2 engine body
3, 3A, 3B fuel supply apparatus
7, 7A, 7B governor mechanism
8 cover member (first cover)
9 guard member (cover member)
31 fuel injection pump
70 lever member
71, 72 adjustment portion
74, 75 cap (sealing portion)
76 rotation stopping portion
78 inner lever
86 projection
87 second cover
310 body
701 (first) contact piece
702 (second) contact piece
703 first restriction portion (maintaining structure)
704 through hole
705 second restriction portion (maintaining structure)
706 reinforcing rib
711 contact-side end portion (contact part of adjustment portion with lever member)
712 tip portion (end portion of adjustment portion on side opposite to lever member in longitudinal direction)
714 elastic member
716 nut
717 collar
718 washer
719 flange
742 tapered surface
781 inner contact piece
801, 802 fixing portion
803, 804 upright wall portion
871 hook piece
Ax2 rotation axis

1. A fuel supply apparatus that supplies fuel to an engine body, the fuel supply apparatus comprising:
a governor mechanism that adjusts a supply amount of the fuel to the engine body, wherein
the governor mechanism includes
an adjustment portion that is tightened and fixed to a body and adjusts at least one of an upper limit and a lower limit of the supply amount of the fuel to the engine body in accordance with an amount of tightening relative to the body, and
a sealing portion that restricts a change in the amount of tightening of the adjustment portion.

2. The fuel supply apparatus according to claim 1, wherein
the sealing portion includes a cap having a bottomed tubular shape, the cap attached to the adjustment portion in a manner in which one end portion of the adjustment portion in a longitudinal direction is inserted in the cap, the cap undetachable from the adjustment portion without destruction.

3. The fuel supply apparatus according to claim 2, wherein
the sealing portion further includes a collar located inside the cap, and the one end portion of the adjustment portion in the longitudinal direction penetrates the collar.

4. The fuel supply apparatus according to claim 3, wherein
a nut provided at the one end portion of the adjustment portion in the longitudinal direction has a flange that restricts movement of the collar in a direction of coming off the adjustment portion.

5. The fuel supply apparatus according to claim 2, wherein
the sealing portion further includes a washer that fills a gap between an opening peripheral edge of the cap and the adjustment portion.

6. The fuel supply apparatus according to claim 2, wherein
the sealing portion includes an elastic member located inside the cap, the elastic member attached to the one end portion of the adjustment portion in the longitudinal direction to prevent the cap from coming off the adjustment portion.

7. The fuel supply apparatus according to claim 2, wherein
the sealing portion further includes a rotation stopping portion that restricts rotation of the cap about the adjustment portion.

8. A fuel supply apparatus that supplies fuel to an engine body, the fuel supply apparatus comprising:
a governor mechanism that adjusts a supply amount of the fuel to the engine body, wherein
the governor mechanism includes
a lever member rotatably supported relative to a body, and
an adjustment portion that adjusts a movable range of the lever member, and
the lever member includes a maintaining structure that maintains a positional relationship with the adjustment portion.

9. The fuel supply apparatus according to claim 8, wherein
the maintaining structure includes a first restriction portion that restricts movement of the lever member relative to the adjustment portion in a rotation axis direction of the lever member.

10. The fuel supply apparatus according to claim 9, wherein
the first restriction portion restricts movement of the lever member relative to the adjustment portion in the rotation axis direction of the lever member by contacting the adjustment portion from at least one side in the rotation axis direction of the lever member.

11. The fuel supply apparatus according to claim 8, wherein
the maintaining structure includes a second restriction portion projecting toward a base portion side of the adjustment portion from a contact piece that contacts a tip face of the adjustment portion.

12. The fuel supply apparatus according to claim 8, wherein
the lever member includes an inner contact piece inside the body, and
the adjustment portion limits the movable range of the lever member by contacting the inner contact piece.

13. The fuel supply apparatus according to claim 12, wherein
the inner contact piece is disposed on an inner lever of the lever member, and
the inner lever is an operation element that increases and reduces a supply amount of the fuel in a fuel injection pump.

14. A fuel supply apparatus that supplies fuel to an engine body, the fuel supply apparatus comprising:
a governor mechanism that adjusts a supply amount of the fuel to the engine body, wherein
the governor mechanism includes
a lever member rotatably supported relative to a body,
an adjustment portion that adjusts a movable range of the lever member, and
a cover member that covers at least one of the lever member and the adjustment portion.

15. The fuel supply apparatus according to claim 14, wherein
the cover member covers at least one end portion of the adjustment portion in a longitudinal direction.

16. The fuel supply apparatus according to claim 14, wherein
the governor mechanism further includes, in addition to a first cover serving as the cover member, a second cover that covers a gap between the first cover and the body.

17. The fuel supply apparatus according to claim 16, wherein
the second cover includes a hook piece, and
the first cover includes a projection, and movement of the projection in a direction away from the body is restricted by the projection catching the hook piece.

18. The fuel supply apparatus according to claim 14, wherein
the governor mechanism includes a guard member as the cover member, and
the guard member covers a contact part of the adjustment portion with the lever member.

19. The fuel supply apparatus according to claim 18, wherein
the guard member covers the contact part of the adjustment portion with the lever member from at least one side in a direction perpendicular to the longitudinal direction of the adjustment portion.

20. The fuel supply apparatus according to claim 18, wherein
the guard member covers the contact part of the adjustment portion with the lever member from at least one side in the longitudinal direction of the adjustment portion.
